(19) United States
(12) Patent Application Publication
(10) Pub. No.: US 2023/0215239 A1
(43) Pub. Date: Jul. 6, 2023

(54) DISPENSING OF CONTROLLED/RESTRICTED ITEMS

(71) Applicant: Tarmore Technologies Pty Ltd, Mount Lawley (AU)

(72) Inventors: Kenneth James Weir Paterson, Mount Lawley (AU); Mark Dunscombe, Moray (GB)

(21) Appl. No.: 17/919,054

(22) PCT Filed: Apr. 16, 2021
(86) PCT No.: PCT/AU2021/050343

§ 371 Date: Oct. 14, 2022

(30) Foreign Application Priority Data
Apr. 16, 2020 (AU) 2020901213

(51) Int. Cl. G07F 17/00; G07F 7/08; G06Q 30/0601

(52) U.S. Cl. CPC G07F 17/0092; G07F 7/08; G06Q 30/0607

(57) ABSTRACT

In one aspect, a system (5) for facilitating procurement of a controlled or restricted item requested by a consumer via a dispensing event is disclosed. In one embodiment, the system is configured operable for enabling an authentication event in respect of the consumer's request, the authentication event involving an identifier and a characteristic associated with the identifier which provides an indication of successful verification of the consumer's eligibility to procure the controlled or restricted item. The system (5) is further configured operable for authorising dispensing of the controlled or restricted item by way of the dispensing event on a determination of the characteristic indicating successful verification of the consumer's eligibility to procure the item following acknowledgment of the identifier on presentation of same at the dispensing event.

### TECHNICAL FIELD

A system for use in the dispensing of controlled or restricted items is disclosed.

### BACKGROUND

Food/beverage product dispensing machines exist in numerous varieties, depending upon the nature of the items being dispensed. Food/beverage products dispensed by such machines may be solid or liquid, and may be dispensed at various temperatures. Dispensing of pre-packaged food/beverage products is typical of most existing dispensing/vending machines.

Vending/dispensing of items that attract a requirement of the consumer to comply with applicable criteria (for example, legal requirements) is challenging to implement in the context of remote vending. Where procurement of any controlled or restricted item is subject to age requirements for legal purposes (such as for example, in the case of alcoholic beverages), compliance with the relevant requirements is necessary in order to legally undertake and complete the transaction.

In current times, there is an affirmative drive to reduce, or at the least contribute to the reduction, of carbon emissions (and lower the highly intensive energy requirements and reduce strain on natural resources) where possible. It has been recognised that excess use of packaging contributes significantly to waste generation. It follows that packaging of high volume consumables contributes greatly to end of chain waste and results from a high carbon footprint. For the case of many controlled or restricted items such as alcohol, packaging is a key element in the supply/marketing of such items. Many such items are packaged in glass within individual paper boxes, within cardboard cartons and packed on pallets that are plastic wrapped for sale purposes, following which the plastic is discarded (all items are generally discarded with little recycling). Accordingly, reducing the demand for such packaging items has the potential to reduce the related carbon footprint.

Accordingly, it is against this background that the embodiments described herein have been developed whereby the inventors have developed a system in which improvements in existing vending systems/processes can be used to beneficial effect in reducing demand in packaged consumables.

### SUMMARY

According to a first principal aspect, there is provided a system for facilitating procurement of a controlled or restricted item requested by a consumer, the system configured operable for enabling an authentication event in respect of the consumer's request, the authentication event involving an identifier and a characteristic associated with the identifier which provides an indication of successful verification of the consumer's eligibility to procure the controlled or restricted item, the identifier being associated with a type of the controlled or restricted item,

the system is further configured operable for authorising dispensing of the controlled or restricted item by way of a dispensing event on a determination of the characteristic indicating successful verification of the consumer's eligibility to procure the controlled or restricted item following acknowledgment of the identifier on presentation of the identifier at the dispensing event.

In an embodiment, the procurement of the controlled or restricted item is requested from one of a network of a plurality of dispensing modules.

In an embodiment, the type is one of more of: the specific product (eg. brand, sub-brand, age etc.), the specific quantity of the item (eg. volume, weight, units).

In one embodiment, the identifier is physically associated with a receptacle device for receiving the controlled or restricted item.

In one embodiment, the system is configured to only facilitate procurement of the controlled or restricted item of the type associated with the identifier into the receptable device associated with the identifier. In an embodiment the dispensing modules are configured to only facilitate procurement of the controlled or restricted item of the type associated with the identifier into the receptable device associated with the identifier.

In an embodiment, the system is configured to record an association of the consumer with the identifier.

In an embodiment, the system is configured to read the identifier and to receive the type of item associated therewith and to dispense the item according to its type into the receptacle device upon the indication of the successful verification of the consumer's eligibility to procure the controlled or restricted item.

In an embodiment, the dispensing module is configured to read the identifier from the receptacle device, wherein reading of the identifier triggers retrieving the type of item associated with the identifier and initiates the verification of the consumer's eligibility to procure the controlled or restricted item.

In an embodiment, the receptacle device comprises a receptacle and a holder device for holding the receptacle. In an embodiment the holder device supports the identifier.

In one embodiment, the system is enabled, at least in part, by way of being arranged in communicative relation with a computing network. In one form, the computing network is a communication network. In another form, the computing network is provided in communicative relation with a network or system.

In one embodiment, the dispensing event involves dispensing of the controlled or restricted item from one of a network of a plurality of dispensing modules. In this manner, the system is configured operable for authorising dispensing of the controlled or restricted item from the dispensing module on a determination of the characteristic indicating successful verification of the consumer's eligibility to procure the controlled or restricted item following acknowledgment of the identifier on presentation of same at the dispensing module.

In an embodiment, upon reading of the identifier the system prepares the dispensing module to dispense the type of item associated with the identifier.

In one embodiment, the dispensing event involves dispensing of the controlled or restricted item by way of a human interface. In another form, the dispensing event involves the dispensing of the controlled or restricted item by way of a human interface at a distribution point.

In one embodiment, the system is arranged in communicative relation with the network of dispensing modules. In one embodiment, each of the dispensing modules is arranged in communicative relation with the computing network by way of the cloud-based network or system.

In one embodiment, enabling of the authentication event in respect of the consumer's request involving the identifier and any modification of the characteristic in providing the indication of successful verification of the consumer's eligibility to procure the controlled or restricted item is controlled or managed by way of a suitable processor, processing server, or control module of the computing network.

In one embodiment, the characteristic is defined or modified following successful verification of the consumer's eligibility to procure the controlled or restricted item in accordance with relevant criteria.

In one embodiment, undertaking of the verification of the consumer's eligibility to procure the controlled or restricted item is part of a first mode of operation of the system in which the consumer seeks to procure a first dispensing of the controlled or restricted item. In an embodiment, the first mode of operation comprises dispensing the controlled or restricted item of the type associated with the identifier into the receptacle.

In one embodiment, the system is configured to enable a second mode of operation in which the consumer seeks to procure further or subsequent dispensing from the dispensing module (hereinafter, further dispensing events). In an embodiment, the second mode of operation comprises dispensing the controlled or restricted item of the type associated with the identifier into the receptacle on a subsequent occasion to the first dispensing.

In one embodiment, defining or modification of the characteristic for providing successful verification of the consumer's eligibility to procure the controlled or restricted item is informed by either of: a manual scrutiny (for verification purposes) of information supporting the consumer's compliance with regard to relevant criteria as might be required in the procurement of the controlled or restricted item or, a substantially automatic or autonomous verification (using, for example, computer vision means of artificial intelligence (AI) means) of the information supporting the consumer's compliance with relevant criteria as might be required in the procurement of the controlled or restricted item by way of appropriate scrutiny of digital equivalents thereof (for example, scanned or digitised versions of the relevant supporting information/documents) provided by the consumer to the computing network.

In one embodiment, authorising dispensing of the controlled or restricted item from the dispensing module on the determination of the characteristic indicating successful verification of the consumer's eligibility to procure the controlled or restricted item is controlled or managed by way of a suitable processor or control module of the computing network.

In one embodiment, the identifier is a unique identifying element. In one embodiment, the identifier is predetermined and or not subject to change.

In one embodiment, the identifier is associated with the consumer so that the consumer is known by the dispensing module and or the computing network when the identifier is presented to/at any of the dispensing modules from which the controlled or restricted item is sought to be dispensed from.

In one embodiment, the identifier and any of the dispensing modules are configured so as to be compatible or registrable with each other, physically or otherwise.

In another embodiment, said compatibility or registrability between the identifier and any of the dispensing modules involves the identifier being communicatively compatible or registrable with any of the dispensing modules so that the identifier can be acknowledged by any of the dispensing modules when the identifier is presented thereat.

In one embodiment, the dispensing module is configured to verify that the receptacle device complies with dispensing requirements. In an embodiment the dispensing requirements comprise requirements of the physical characteristics of the receptacle (for example height, width, weight). In an embodiment the dispensing requirements comprise checking that the dispensing module is able to dispense the type and/or quantity of the item associated with the identifier.

In one embodiment, the controlled or restricted item comprises any item where its procurement by a consumer is controlled by way of an act or instrument of legislation or regulation.

In one embodiment, the controlled or restricted item comprises any form of pharmaceutical medicament (and or their respective carriers or dispensers) of various composition, such as tablets, capsules, inhalers, inhalers, implants, patches, gels, creams, liquids, or otherwise (hereinafter, medicaments), and which could be dispensed as part of the dispensing event, for example, from an appropriately configured dispensing module or made available at a distribution point involving a human interface (for example, a pharmacist).

In one embodiment, the controlled or restricted item (hereinafter, item) comprises an alcoholic beverage (such as for example, gin, whisky/whiskey, vodka—hereinafter, beverage), but could be any item in which its procurement is legally allowable by consumers satisfying one or more criteria defined by way of domestic legislation or regulation (eg. cigarettes).

In one embodiment, verification of the consumer's eligibility to procure a beverage comprises verification that the consumer's legal age is compliant with the relevant domestic legislation/regulation in the procuring of alcoholic beverages. In one embodiment, age verification is conducted manually or substantially automatically or autonomously via an online platform associated with the computing network (using, for example, appropriately configured AI technology).

In one embodiment, verification of the legal age of the consumer is enabled by way of receiving, on provision by the consumer, physical documentation (for example, appropriate personal identification documentation) evidencing the legal age of the consumer for scrutiny (by human or technological means) by way of: receipt of the personal identification documentation via a physical manner; or receipt of the documentation via a substantially digital process (for example, via scanning/reading technology configured operable for scanning the identification documentation for assessment purposes, and or which may involve appropriate analysis/assessment of image/photo verification).

In one embodiment, the characteristic comprises an indication as to a status of the identifier. In one form, the status of the identifier is operable for indicating at least one of two states: an Inactive' state, an ‘active’ state.

In one embodiment, the characteristic of the identifier comprises an indication as to whether the consumer's request relates to, and or is approved for, a first dispensing event sought from any of the dispensing modules, or indicates whether the consumer's request relates to, and or is approved for, one or more further dispensing events, following the first dispensing event, sought from any of the dispensing modules. For example, the characteristic of the identifier may be arranged so as to indicate whether the consumer is, for example, a ‘first user’ (where, for example, the characteristic indicates that the consumer is authorised by the computing network for undertaking a single dispensing event from a selected dispensing module), or a ‘long time’ or ‘ongoing’ user (where, for example, the characteristic indicates that the consumer is authorised by the computing network for undertaking more than one further dispensing events from a selected dispensing module).

In one embodiment, the characteristic of the identifier is arranged so as to provide an indication of a credit having been conferred to the consumer on completion of a payment transaction in respect of the first dispensing event, and or in relation to any further dispensing event sought by the consumer.

In one embodiment, successful verification of the consumer's age (for example, the consumer being confirmed or verified as being of sufficient age for legally procuring the item) and or identity involves revising or modifying the status of the identifier. In one form, the status of the identifier is revised so as to reflect an ‘active’ status of the identifier.

In one embodiment, prior to successful verification of the consumer's age, the characteristic of the identifier indicates the identifier as being in an ‘inactive’ state.

In one embodiment, the revised status of the identifier, on change to an ‘active’ status, is registered or stored with the computing network.

In one embodiment, determination of the status of the identifier comprises the dispensing module seeking from the computing network, either directly or via the cloud-based network/system, validation or accordance of the status of the identifier (so as to confirm the status of the identifier: whether ‘active, or ‘inactive’) on acknowledgement of the identifier following presentation at one of the dispensing modules by the consumer.

In one embodiment, the characteristic, on revision to indicate successful verification of the consumer's eligibility to procure the item (eg. changing the status of the characteristic from the ‘inactive’ state to the ‘active’ state), may be:
(i) communicated to any of the dispensing modules (for storage thereby) by way of the computing network and or cloud-based network/system, or
(ii) registered or stored with the computing network following successful verification and made available to be queried or acknowledged (or otherwise ascertainable) by any of the dispensing modules following the identifier being presented thereat by the consumer.

In one embodiment, the revised status of the characteristic is communicated to a dispensing module on request from the relevant dispensing module.

In one form, communication to any dispensing module of the status (revised or otherwise) of the characteristic of the identifier follows, or is substantially triggered by, presentation of the identifier at the dispensing module by the consumer.

In one embodiment, the receptacle device is presentable at any of the dispensing modules by the consumer in the procurement of an item.

In one embodiment, the holder device is configured for associating with a liquid receptacle (such as for example, a bottle—hereinafter, bottle) into which the item (for example, a selected beverage) the subject of any procurement request of the consumer is dispensed into by the relevant dispensing module.

In one embodiment, the holder device is configured for supporting or holding the bottle.

In one embodiment, the holder device is provided in the form of a sleeve or tube segment (or tubular section/segment) having a base closing an end of the sleeve and operable for receiving and supporting the bottle. In an embodiment the holder device comprises a physical compatibility interface with an item holder/receptacle. Typically, the physical compatibility interface is a keyed projection on the sleeve and a recess on the bottle.

Advantageously, the receptacle is separable from the holder device, for example for cleaning.

In one embodiment, the holder device and bottle are purchased by the consumer for use with the system for the purpose of procuring the beverage, either for a single transaction (for example, a first dispensing event), or for one or more future transactions (for example, further dispensing events). In this manner, the holder device and the bottle remain with the consumer and are reused for each subsequent transaction (or dispensing event).

Advantageously, the receptacle is re-useable.

In one embodiment, the bottle is configured for use with a specific type of beverage dispensable from any of the dispensing modules.

In one embodiment, the holder device is configured for use with a specific type of bottle (for example, a bottle configured for accommodating a specific volume of a dispensed beverage).

In one embodiment, the bottle is configured for accommodating a specific volume of a dispensed beverage. For example, one bottle available for purchase by the consumer is configured for accommodating 700 ml of dispensed beverage, and another bottle available for purchase by the consumer is configured for accommodating 1 litre of dispensed beverage. Of course, other volumes may be provided for.

In one embodiment, a holder device is configured for use with a bottle configured having a specific volumetric capacity. In this manner, bottles sharing the same volumetric capacity can be used in an interchangeable manner with a holder device configured for use with bottles having that same volumetric capacity. In this manner, for example, a device holder for use with bottles having a 700 ml volumetric capacity can be used with any 700 ml capable bottle regardless of which type of beverage the bottle is configured for use with. Thus, for example, a consumer having a first 700 ml bottle configured for specific use with vodka, and second 700 ml bottle configured for use with gin, can procure refills of both bottles using the same holder device. In cases where multiple holder devices are owned by the same consumer, the unique identifiers of each holder device will be associated with the consumer (eg. being linked or attached with the consumer's account with the computing network).

In one embodiment, respective dimensions of a height of the holder device and a bottle (regardless of the volumetric capacity of the bottle) are configured so as to be substantially the same, whereby the respective diameters of the holder device and the bottle are selected as appropriate so as to accommodate different volumes of the dispensed beverage.

In one embodiment, the dispensing module is configured so as to operate with bottles (and respective holder devices) configured for accommodating different volumes of dispensed beverage. For example, in achieving such compatibility between bottles of different volume, respective dimensions of a height of the holder device and a bottle (regardless of the volumetric capacity of the bottle) are configured so as to be substantially the same, whereby the respective diameters of the holder device and the bottle are variable as appropriate so as to accommodate different volumes of the dispensed beverage. In this manner, respective heights of a holder device and bottle configured for holding a first volumetric capacity (for example, 700 ml) is substantially the same as the respective heights of a holder device and bottle configured for holding a second volumetric capacity (for example, 1 litre). In this manner, a standardised height of the device holder/bottle can be commensurate with a dimension of a means for receiving (an entry region to a portion of a dispensing module that is operable for dispensing a selected beverage) the holder device/bottle at any of the dispensing modules in the network.

In one embodiment, the holder device and the bottle are configured so as to be registrable with each other. In this manner, registration between the bottle and the holder device operates to properly locate or pair both components together for convenient carriage and or use with the relevant dispensing module for the purpose of the bottle receiving a quantity of the dispensed beverage.

In one embodiment, registration between the bottle and the holder device occurs between a portion of the bottle at or near an external facing region of its base, and a portion of the holder device at or near an internal facing region of its base.

In one embodiment, the registration between the bottle and the holder device involves respective engaging or interacting portions formed or shaped of a substantially complimentary nature suitable for mutual engagement or interaction.

In one embodiment, registration between the bottle and the holder device is for positional location purposes (for example, for confirming relative positioning therebetween) and or provides for releasable securement (for example, providing an affirmative registration therebetween, for example, a ‘push-fit’ or ‘click-fit’ engagement) so as to provide the physical compatibility interface. In an embodiment, the physical comparability interface comprises a physical registration.

In one embodiment, the identifier is provided (for example, stored with or on) in the form of near field identifier, such as a radio frequency identifier (RFID) module or chip.

In one embodiment, the RFID module or chip is associated with the holder device.

In one embodiment, the RFID module or chip is configured for ‘read only’ operations.

In one embodiment, the RFID module or chip is provided integral with the holder device.

In one embodiment, the RFID module or chip is releasably securable with the holder device.

In one embodiment, the system is operable to enable the undertaking of one or more additional authentication events using any information provided by the consumer.

In one embodiment, the system is configured operable to enable a verification event when the consumer presents at one of the dispensing modules seeking to further procure beverage(s) (for example, one or more refills of the beverage) therefrom subsequent to the first dispensing event undertaken by the consumer. In one embodiment, the verification event is part of a second mode of operation of the system. In this manner, the verification event operates to verify the identity of the consumer with the computing network (via the dispensing module) when the consumer presents at any of the dispensing modules for the purpose of seeking further procurement of a beverage.

In one embodiment, the system is configured to receive a personal identifier from the consumer and verifies the identity of the consumer prior to dispensing the item.

In an embodiment, the system is configured to receive the personal identifier only when the consumer is proximal to the dispensing module.

In one embodiment, the verification event involves a second identifier associated with the consumer and used for the purpose of verifying the identity of the consumer with the computing network when the second identifier is presented at the relevant dispensing module in addition to the presentation of the identifier of the authentication event.

In one embodiment, the second identifier, once established, may be:
(i) communicated to any of the dispensing modules (for storage thereby) by way of the computing network and or cloud-based network/system, or
(ii) registered or stored with the computing network and made available to be queried or acknowledged (or otherwise ascertainable) by any of the dispensing modules following the second identifier being presented thereat by the consumer.

In one embodiment, the consumer is required by the system to provide requisite information in the event the consumer seeks to undertake further dispensing events beyond that of the first dispensing event, which information provides basis for the second identifier. In one form, the second identifier is created or generated by the consumer (for example, in the form of a personal passcode). In another form, the consumer requests or elects for the computing network to provide (create or generate) the second identifier, which is then communicated (using any appropriate communication means) to the consumer for presentation at a dispensing module.

In one embodiment, the second identifier is associated with a characteristic for use in providing an indication of the consumer being authorised to procure another beverage from any of the dispensing modules subsequent to an initial dispensing event from any dispensing module.

In one form, the characteristic associated with the second identifier is associated with the consumer on the consumer providing the requisite information.

In one embodiment, the second identifier, whether created or generated by the consumer or by the computing network, is used by the consumer for further dispensing events at any of the dispensing modules. Accordingly, in one embodiment, creation/generation of the second identifier is required of the consumer for future or further dispensing events beyond the first dispensing event.

In one embodiment, the system is configured operable for facilitating or enabling the consumer to provide the requisite information.

In one embodiment, enabling of the consumer to provide the requisite information is by way of the computing network inviting (by way of an appropriate means of communication) the consumer to provide the requisite information. In one form, the inviting of the consumer to provide the requisite information is by way of the computing network sending the consumer a link to a webpage, for example, where the requisite information can be provided.

In one embodiment, the means by which the computing network communicates with the consumer is elected by the consumer and provided to the computing network (for example, during the first dispensing event).

In one embodiment, the system is configured operable for authorising dispensing of a beverage from the relevant dispensing module on a determination of the characteristic of the identifier (of the authentication event) indicating successful verification of the consumer's eligibility to procure a beverage following acknowledgment of said identifier on presentation of same at any of the dispensing modules, and on a determination of the second identifier indicating that the consumer is authorised to procure a beverage following acknowledgment of the second identifier on presentation of same at the relevant dispensing module.

In one embodiment, upon the consumer providing the requisite information to the computing network, the characteristic associated with the second identifier is modified so as to indicate a status of the second identifier. In one form, the status of the second identifier indicated by the characteristic of the second identifier is an ‘active’ state. In one form, the ‘active’ state indicated by the characteristic of the second identifier indicates that the consumer is authorised to receive dispensing of a beverage sought by the consumer from any of the dispensing modules. For example, on the consumer providing the requisite information to the computing network, the characteristic associated with the second identifier is modified so as to indicate a status of the second identifier as a reference to the consumer being registered as an authorised ‘long term’ or ‘on-going’ consumer/user (or account holder) with the computing network and therefore authorised to undertake further dispensing events.

In one embodiment, the system is configured operable for authorising dispensing of a beverage from the relevant dispensing module on a determination of the characteristic of the identifier (of the authentication event) indicating successful verification of the consumer's eligibility to procure a beverage following acknowledgment of said identifier on presentation of same at any of the dispensing modules, and on a determination of the characteristic of the second identifier indicating that the consumer is authorised to procure a beverage following acknowledgment of the second identifier on presentation of same at the relevant dispensing module.

In one embodiment, a change of status of the characteristic of the second identifier occurs when the consumer provides by way of the computing network the requisite information relating to the consumer, any of which information may be used (either individually or in combination) as the second identifier.

In one embodiment, the system is configured so as to enable a further verification event involving a third identifier associated with the consumer and used for the purpose of verifying the identity of the consumer with the system or relevant computing network. In one form, the third identifier is generated independent of the system and the consumer. In one form, the system and the consumer are made aware of the third identifier by independent means. In one form, the third identifier is unique to the consumer. In one form, the third identifier is generated by a third-party authentication service that is in communicative relation with the system so that the system is able to verify the third identifier on provision of same by the consumer at a dispensing module. In one form, the third identifier generated by the third-party authentication service is made available to the consumer by way of the user's portable device being in communication with a computing network enabling the third-party authentication service (for example, said communication being by way of a software application (or similar means) operable on the consumer's portable device).

In one embodiment, the third identifier generated by the third-party authentication service is valid for a period of time (which period of time could change over the course of a longer period of time). Optionally, the third identifier is generated in an on-going or continuous manner and updated at the expiry of a period of time.

In one embodiment, a component of the information required to be provided by the consumer to the system is the details of the third-party authentication service to which the consumer is subscribed, so that the system is able to establish a communicative link with the service for ‘synchronisation’ purposes.

In one embodiment, the requisite information required of the consumer comprises any of the following: name, date of birth, age, phone number, email address, physical address, credit card details, further information for verification of age, consumer created or generated passcode/password, agreement by the consumer to one or more terms or conditions required for the procurement of further beverage(s) dispensing events (agreement to legal, health and safety considerations), responsibility for hygiene of the bottle, understanding of effects of alcohol on health, setting of preferences such as payment details (credit card, etc), nickname/avatar details, election/request for computing network to generate the second identifier associated with the consumer, details of a third-party authentication service preferred by the consumer (which third-party authentication service generates the third identifier so that the system is able to ‘synchronise’ with the third-party authentication service in operating to verify the identity the consumer when undertaking a further dispensing event (in one form, the consumer will be prompted during account set-up to open an account with an appropriate third-party authentication service if they are not already subscribed to one).

In one embodiment, the second identifier is created or generated by the computing network for use by the consumer at any of the dispensing modules. In one embodiment, when created or generated by the computing network, the second identifier is communicated to the consumer (for example, by any appropriate communication means, such as for example, an email, a short message service (SMS) broadcast).

In one embodiment, creation or generation of the second identifier by the computing network is actioned or enabled at the consumer's request or election, for example, by way of acknowledging an option selected/elected by the consumer when providing the requisite information.

In one embodiment, the system is configured so that the second identifier created or generated by the consumer can be changed by the consumer at any time by the consumer.

In one embodiment, enabling of the consumer to create/generate/amend the second identifier is by way of an interface associated with any dispensing module from which a beverage is sought to be dispensed from.

In one embodiment, enabling of the consumer to create/generate/amend the second identifier is by way of an interface provided via an electronic device in communication with the computing network or cloud-based network/system, comprising, for example, a portable electronic device, a non-portable electronic device, a desktop computer, or similar.

In one embodiment, the creation/generation/amending of the second identifier by the consumer is as a consequence of the consumer seeking further procurement of a beverage from any of the dispensing modules beyond the initial dispensing event.

In one embodiment, the system is configured operable for facilitating or enabling the consumer to provide information to the computing network for use in payment of a beverage dispensing event, such as for example, credit card details, payment service (for example, Paypal™) details, and the like. In one embodiment, provision of the information for payment of a beverage is provided by the consumer at the relevant dispensing module or could be provided by way of an electronic device in communication with the computing network, the electronic device comprising, for example, a portable electronic device, a non-portable electronic device, a desktop computer, or similar. In one form, provision of the payment information is for a single transaction. In another form, the payment information is provided in respect of more than one future transactions.

It will be appreciated that any information provided by the consumer may be used for verifying the consumer with the computing network, favourable resolution of which occurs on the accuracy of the information being confirmed or validated with the computing network when provided by the consumer at the relevant dispensing module.

In one embodiment, the or each dispensing module is provided in the form of a dispensing facility configured operable for dispensing one or more of the items/beverages.

In one embodiment, the or each dispensing module is provided in the form of a vending machine.

In one embodiment, the or each dispensing module comprises one or more of the following:
an interface module for allowing the consumer to interface with the dispensing module and or the computing network;
an interface module for allowing the consumer to select an item/beverage to procure;
a module for powering and reading an RFID chip;
an interface module for allowing the consumer to input, edit, or revise their consumer created/generated second identifier (for example, a passcode or password);
a module for enabling communication with the computing network/cloud based network;
a module for dispensing one or more items/beverages stored with the relevant dispensing module;
a processor module configuration enabling operation of the dispensing module;
an interface module operable for displaying marketing and or promotional material (for example, the interface module may be configured so as to display such material while awaiting use by a consumer).

In one embodiment, the interface module comprises a touch screen.

In one embodiment, the or each dispensing module comprises appropriate control electronics, circuitry, and or soft/firmware operable for enabling interfacing between the consumer and the relevant dispensing module for the purposes of completing the authentication and or verification events in the procurement of the item(s)/beverage(s).

In one embodiment, the holder device and any of the dispensing modules are configured so as to be physically compatible or registrable with each other. In this manner, registration between any of the dispensing modules and the holder device operates to properly locate the holder device in position for the purpose of the bottle receiving a quantity of the item/beverage during a dispensing event. In an embodiment the dispensing module comprises a receptacle device receiving portion configured to receive the receptacle device. In an embodiment the receptacle device receiving portion is configured to check the physical requirements of the receptacle device. In an embodiment the receptacle device receiving portion is configured to dispense the item into the receptacle device. In an embodiment the receptacle device receiving portion is configured to communicate with the holder device of the receptacle device to receive the identifier. In an embodiment the receptacle device receiving portion is configured operable to make safe from volatiles/flammables before, during and/or after dispensing.

In one embodiment, physical registration between any of the dispensing modules and the holder device is by way of complimentary formations/shaped features provided on both components, the interaction/engagement of which is for positional location purposes (for example, to confirm relative positioning therebetween).

In one embodiment, physical registration between any of the dispensing modules and the holder device is for releasable securement (for example, providing an affirmative registration therebetween) between both components.

According to a second principal aspect, there is provided a system for facilitating procurement of a controlled or restricted item requested by a consumer from one of a network of a plurality of dispensing modules, the system configured operable for enabling an authentication event in respect of the consumer's request, the authentication event involving an identifier and a characteristic associated with the identifier which provides an indication of successful verification of the consumer's eligibility to procure the controlled or restricted item, wherein the identifier is physically associated with a receptacle device for receiving the controlled or restricted item,

the system is further configured operable for authorising dispensing of the controlled or restricted item from the dispensing module on a determination of the characteristic indicating successful verification of the consumer's eligibility to procure the controlled or restricted item following acknowledgment of the identifier on presentation of the identifier at any of the dispensing modules.

According to a third principal aspect, there is provided a system for facilitating procurement of a controlled or restricted item requested by a consumer from one of a network of a plurality of dispensing modules, the system configured operable for enabling an authentication event in respect of the consumer's request, the authentication event involving an identifier and a characteristic associated with the identifier which provides an indication of successful verification of the consumer's eligibility to procure the controlled or restricted item,

the system is further configured operable for authorising dispensing of the controlled or restricted item from the dispensing module on a determination of the characteristic indicating successful verification of the consumer's eligibility to procure the controlled or restricted item following acknowledgment of the identifier on presentation of the identifier at any of the dispensing modules,

the system is further configured operable to dispense the controlled or restricted item from the dispensing module into a receptacle device comprising a physical compatibility feature,

the system is further configured operable to check the physical compatibility feature.

According to a fourth principal aspect, there is provided a system for facilitating procurement of a controlled or restricted item requested by a consumer from one of a network of a plurality of dispensing modules, the system configured operable for receiving an identifier related to an authentication event undertaken in respect of the consumer's request, the authentication event involving a characteristic associated with the identifier which provides an indication of successful verification of the consumer's eligibility to procure the controlled or restricted item, the identifier being associated with a type of the controlled or restricted item and/or a receptacle device for receiving the controlled or restricted item,

the system further configured operable for authorising dispensing of the controlled or restricted item from the dispensing module on determination of the characteristic indicating successful verification of the consumer's eligibility to procure the controlled or restricted item following acknowledgment of the identifier on presentation of the identifier at any of the dispensing modules.

According to a fifth principal aspect, there is provided a method for facilitating procurement of a controlled or restricted item requested by a consumer from one of a network of a plurality of dispensing modules, the method comprising:

enabling an authentication event in respect of the consumer's request, the authentication event involving an identifier and a characteristic associated with the identifier which provides an indication of successful verification of the consumer's eligibility to procure the controlled or restricted item,

associating the identifier with a type of the controlled or restricted item and/or a receptacle device for receiving the controlled or restricted item, and

authorising dispensing of the controlled or restricted item from the dispensing module on a determination of the characteristic indicating successful verification of the consumer's eligibility to procure the controlled or restricted item following acknowledgment of the identifier on presentation of same at any of the dispensing modules.

In one embodiment, the systems of any of the principal aspects described herein can be enabled by way of a dispensing machine, such as for example, an appropriately configured dispensing apparatus, such as for example, a vending machine.

Accordingly, in a sixth principal aspect, there is provided, a dispensing apparatus for use in procurement of a controlled or restricted item requested by a consumer there from, the dispensing apparatus configured operable for receiving an identifier related to an authentication event undertaken in respect of the consumer's request, the authentication event involving a characteristic associated with the identifier which provides an indication of successful verification of the consumer's eligibility to procure the controlled or restricted item, the identifier being associated with a type of the controlled or restricted item and/or a receptacle device for receiving the controlled or restricted item, and

the dispensing apparatus further configured operable for authorising dispensing of the controlled or restricted item from on determination of the characteristic indicating successful verification of the consumer's eligibility to procure the controlled or restricted item following acknowledgment of the identifier on presentation of the identifier at the dispensing apparatus.

According to a seventh principal aspect, there is provided a system for facilitating procurement of a controlled or restricted item requested by a consumer from one of a network of a plurality of dispensing modules, the system configured operable for enabling a first mode of operation involving an authentication event in respect of the consumer's request, the authentication event involving an identifier and a characteristic associated with the identifier which provides an indication of successful verification of the consumer's eligibility to procure the controlled or restricted item, the identifier being associated with a type of the controlled or restricted item and/or a receptacle device for receiving the controlled or restricted item,

the system configured operable for authorising dispensing of the controlled or restricted item from the dispensing module on a determination of the characteristic indicating successful verification of the consumer's eligibility to procure the controlled or restricted item following acknowledgment of the identifier on presentation of the identifier at any of the dispensing modules,

the system further configured for enabling a second mode of operation involving a verification event involving a second identifier associated with the consumer for use in verifying the consumer as the consumer associated with the authentication event,

the system configured operable for authorising dispensing of a further controlled or restricted item on a determination of the characteristic indicating successful verification of the consumer's eligibility to procure the controlled or restricted item following acknowledgment of the identifier on presentation of same at any of the dispensing modules and on a determination of the second identifier indicating that the consumer as being the consumer associated with the authentication event following acknowledgment of the second identifier on presentation of same at the relevant dispensing module.

According to an eighth principal aspect, there is provided a system for facilitating procurement of a controlled or restricted item requested by a consumer via a dispensing event, the system configured operable for enabling a first mode of operation involving an authentication event in respect of the consumer's request, the authentication event involving an identifier and a characteristic associated with the identifier which provides an indication of successful verification of the consumer's eligibility to procure the controlled or restricted item, the identifier being associated with a type of the controlled or restricted item and/or a receptacle device for receiving the controlled or restricted item,

the system configured operable for authorising dispensing of the controlled or restricted item from the dispensing module on a determination of the characteristic indicating successful verification of the consumer's eligibility to procure the controlled or restricted item following acknowledgment of the identifier on presentation of the identifier at the dispensing event,

the system further configured for enabling a second mode of operation involving a verification event involving a second identifier associated with the consumer for use in verifying the consumer as the consumer associated with the authentication event,

the system configured operable for authorising dispensing of a further controlled or restricted item on a determination of the characteristic indicating successful verification of the consumer's eligibility to procure the controlled or restricted item following acknowledgment of the identifier on presentation of same at another dispensing event and on a determination of the second identifier indicating that the consumer as being the consumer associated with the authentication event following acknowledgment of the second identifier on presentation of same at said another dispensing event.

According to a further principal aspect, there is provided a device configured for holding or providing support for a receptacle, the device comprising an identifier configured operable so as to be acknowledgeable for use in an authentication event enabled by a system for facilitating procurement of a controlled or restricted item requested by a consumer from one of a network of a plurality of dispensing modules, or acknowledgeable by a dispensing apparatus operable for use in procurement of a controlled or restricted item when the device is presented thereto.

In one embodiment, the device comprises a physical compatibility feature with the receptacle.

Each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

In this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive concept/principles may be exemplified.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made with reference to the accompanying drawings in which:

FIG. 1 shows a number of elements of one embodiment of a system arranged in accordance with the principles described herein for facilitating procurement of a controlled or restricted item;

FIG. 2 shows one embodiment of a process (Ps) involved with the procurement of a controlled/restricted item for dispensing from any of the plurality of dispensing modules shown in FIG. 1;

FIG. 3 shows one embodiment of a process (Pi) involved with the procurement of a controlled/restricted item for dispensing from any of the plurality of dispensing modules shown in FIG. 1;

FIG. 4 shows one embodiment of a process (P2) involved with the procurement of a controlled/restricted item for dispensing from any of the plurality of dispensing modules shown in FIG. 1;

FIG. 5 shows one embodiment of a process (P3) involved with the procurement of a controlled/restricted item for dispensing from any of the plurality of dispensing modules shown in FIG. 1;

FIG. 6 shows one embodiment of a process (P4) involved with the procurement of a controlled/restricted item for dispensing from any of the plurality of dispensing modules shown in FIG. 1;

FIG. 7 shows one embodiment of a process (Ps) involved with the procurement of a controlled/restricted item for dispensing from any of the plurality of dispensing modules shown in FIG. 1; and

FIG. 8 shows a schematic process flow diagram of one embodiment of a process involved with the procurement of a controlled/restricted item for dispensing from any of the plurality of dispensing modules shown in FIG. 1.

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the figures, and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

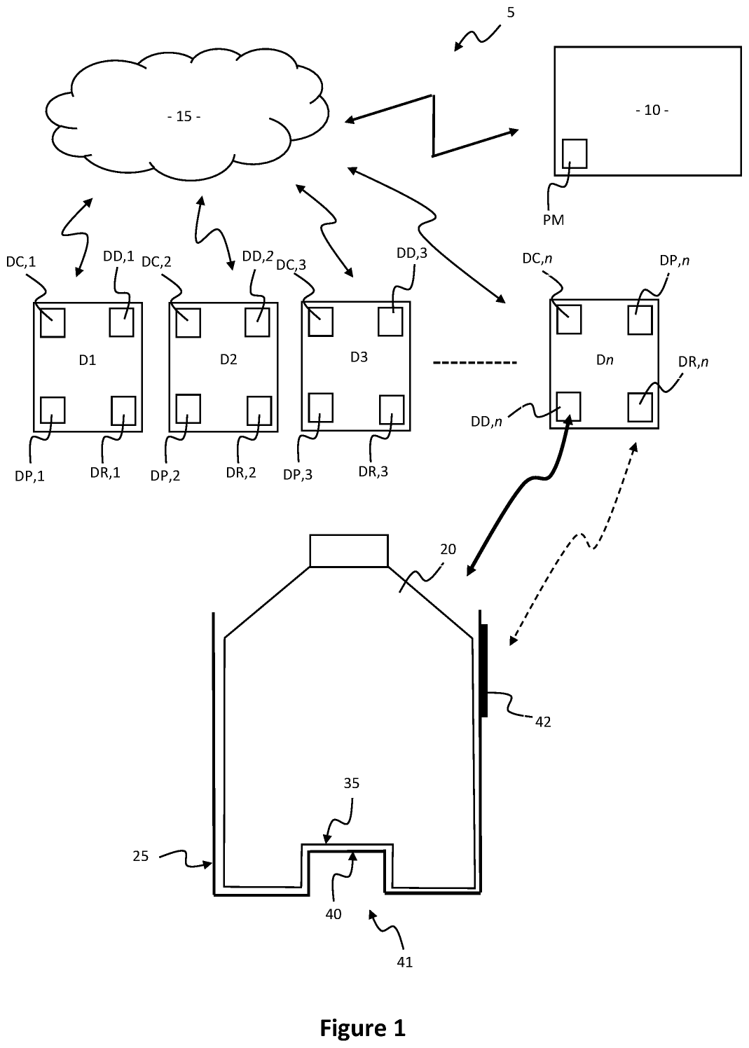

FIG. 1 shows a number of elements involved in one embodiment of a system 5 for facilitating procurement of controlled or restricted items, such as for example, alcoholic beverages (hereinafter, beverage) from any of a plurality of networked remotely located dispensing (vending) apparatus (hereinafter, dispensing modules Dn). In the context described herein, such beverages may comprise alcoholic spirits, for example, gin, whisky/whiskey, vodka. The skilled reader will appreciate that any form of alcoholic beverage (or any form of liquid, such as for example, a liquid medicament) could be procured by way of the system 5. Furthermore, the principles described herein may be used in the procurement of other types of controlled/restricted items (for example, cigarettes). As outlined below, the principles described herein could be applied in providing a system operable in the procurement of any form of pharmaceutical medicament (for example, any pharmaceutical medicament of solid, gel, liquid composition).

The system 5 is configured operable for enabling an authentication event in respect of a request by a consumer to procure such beverages. The authentication event involves an identifier and a characteristic associated with the identifier which operates to provide an indication of successful verification of the consumer's eligibility to procure the beverage. The characteristic represents, in the embodiment described herein, an indication of a status of the identifier being in either an ‘inactive’ state, or an ‘active’ state. In the form described herein, the system 5 enables the authorisation of the dispensing of the beverage from the relevant dispensing module (Dn) on a determination of the characteristic indicating successful verification of the consumer's eligibility to procure the beverage (for example, the consumer being verified as being of appropriate legal age to purchase alcoholic drinks) following acknowledgment of the identifier on presentation of same at any of the dispensing modules Dn. As will be described with regard to the embodiment outlined below, the identifier is provided with (or hosted by) a receptacle holder device (hereinafter, holder device 25) in a manner that is physically associated with the holder device 25. The holder device 25 operates to support a liquid receptacle (provided in the form of a bottle 20) into which a beverage is dispensed from a selected dispensing module Dn.

The identifier is associated with the consumer so that the consumer can be acknowledged by the dispensing module Dn (and or the system 5) when the identifier is presented to/at any of the dispensing modules Dn from which a beverage is sought to be dispensed from. The characteristic is defined or modified following successful verification of the consumer's eligibility to procure the beverage in accordance with relevant criteria. Undertaking of the verification of the consumer's eligibility to procure the beverage is part of a first mode operation of the system 5 in which the consumer seeks to procure a first dispensing of the beverage. As will be described below, the system 5 is configured to enable a second mode of operation in which the consumer seeks to procure additional beverages (for further refills) for dispensing from any of the dispensing modules Dn.

The identifier is also associated with the type of controlled or restricted item, for example when the item is beverage, the type if preferably the type of beverage, such as gin (or more particularly the precise type of gin), whisky, whiskey, vodka, rum etc.

As seen in FIG. 1, the system 5 involves a computing network connecting processor (hereinafter, processor 10) arranged in data communication with a plurality of dispensing modules Dn via a “cloud-based” communication network/environment 15. In this manner, the processor 10 and each of the dispensing modules Dn are configured so as to be capable of communicating with each other in a bi-directional manner via the cloud-based communication network/environment 15. It is to be understood that each of the dispensing modules Dn comprise respective processing modules (and associated electronics, circuitry, soft/firmware) configured for facilitating/enabling such data communication processes so that each is capable of exchanging data (receiving and transmitting) with the processor 10. As broadly seen in FIG. 1, each of the dispensing modules Dn, comprise respective processor modules DP,n for enabling control/operation of the functions to be carried out by the relevant dispensing module Dn, respective communication modules DC,n for enabling data communication/exchange with the processor 10 (via the cloud-based network 15), respective radio frequency identification (RFID) reader modules DR,n for enabling reading/acknowledgement of the identifier (in one form, a RFID chip 42, as will be discussed below) presented to the relevant dispensing module Dn, and respective regions DD,n operable for dispensing selected beverages (or other controlled/restricted items as might be sought/supplied)—referred to herein as access controlled dispensing region(s) DD,n.

The system 5 (via the processor 10) is configured operable to enable a consumer to purchase a desired bottle 20 (of a desired volumetric capacity) into which the selected (alcoholic) beverage (type) can be dispensed at any of the dispensing modules Dn to which the consumer presents. The bottle 20 is operable with the holder device 25 for being held/supported thereby, whereby the holder device, which carries the identifier, is used as part of the authentication event and also can identify the type of beverage to the dispenser modules Dn. The holder device 25 is physically provided with the identifier which, in the present embodiment, is provided in the form of a unique identifying element which is stored on a radio frequency identification (RFID) chip 42. In the present embodiment of the system 5, the RFID chip 42 is physically associated with the holder device 25 in a permanent manner. The skilled reader will be aware of many types of configurations that could be used to achieve such an association. It will also be appreciated that the RFID chip 42 need not be permanently attached but could be releasable/removable. It will be appreciated that various advantages flow from use in the system 5 of the unique identifier being provided in the form of the RFID chip 42, including: a unique identifier being accorded to each consumer, facilitating a fluid or streamlined process for enabling the registration of consumer details and preferences, facilitating a fluid or streamlined process for tracking product from distillery batch to the consumer.

The bottle 20 and the holder device 25 are each configured so as to be registrable with each other so that the bottle 20 can conveniently locate with the holder device 25 and can provide a physical compatibility interface therebetween. As seen in FIG. 1, in at least one embodiment, the bottle 20 is configured having a shaped recess 35 (for example, a dome shaped recess) provided at the underside of its base that can readily register with a complimentary shaped protrusion 40 provided on the interior surface of the base of the holder device 25. As also shown in FIG. 1, the holder device 25 may be provided in the form of a sleeve like segment (or tubular section/segment) having a base closing an end of the sleeve and operable for receiving and supporting the bottle 20. The skilled reader will readily appreciate other types of arrangements that could be possible in forming/providing the holder device 25.

Bottles involved in the system 5 may be individually configured to accommodate different volumes of dispensed beverages. For example, the system 5 may be configured so as to acknowledge a bottle configured with a volumetric capacity of 700 ml, and another bottle having a volumetric capacity of 1 litre. Furthermore, each bottle may be configured (shaped, designed) so as to be used with a specific type of beverage dispensed from any of the dispensing modules Dn. In this manner, a consumer may purchase a number of bottles 20 with each being intended for use with a specific beverage carried by the dispensing modules Dn. Different holder devices 25 may be purchased for use with bottles having a specific volumetric capacity. The identifier can then be associated with the purchased type and/or quantity/volume of beverage. This in turn allows the dispensing modules Dn to determine what and how much to dispense when the identifier is read, as described further below.

The RFID chip 42 of each holder device 25 is provided in a ‘read-only’ form, allowing the unique identifier to be stored on the RFID chip 42 and read from the relevant RFID reader module DR,n located with a respective dispensing module Dn. It will be appreciated that, in the present embodiment, the RFID chip 42 is of the passive form in which no internal power source is provided with the RFID chip 42. In this manner, power for accessing or reading data (ie. the unique identifier) stored on the RFID chip 42 is by way of the electromagnetic energy transmitted from the relevant RFID reader module DR,n for enabling reading of the RFID chip 42 associated with the relevant holder device 25.

Broadly, and as will be outlined below, the system 5 also enables the authentication event which requires a consumer to be subject to a verification process to confirm their eligibility to procure any of the beverage(s) vended by any of the networked dispensing modules Dn. In this manner, compliance with relevant domestic legislation/regulation governing access to alcoholic beverages is tested and confirmed (or otherwise). For the case of the first dispensing event, once such verification is completed successfully (in the consumer's favour), the consumer is able to continue in procuring the selected beverage from any of the dispensing modules Dn on provision of the requisite unique identifier associated with the holder device 25 at the relevant dispensing modules Dn. For the case of further dispensing events, an identity verification event needs to be undertaken involving a second identifier (described below), and, if enabled/required due to relevant legislation/regulation, a third identifier (as described below)—in such cases, evidence of the authentication event having been completed (as part of the first dispensing event) is provided by way of the unique identifier being presented (by way of the RFID chip 42 of the device holder 25) at the relevant dispensing module Dn.

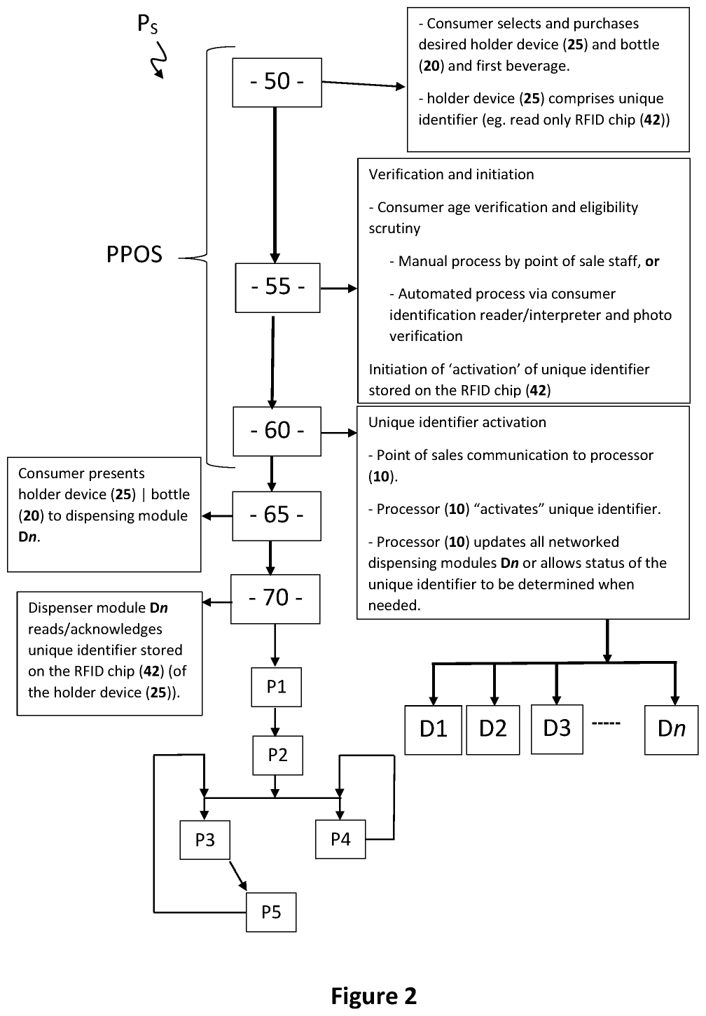

FIG. 2 shows an embodiment of a process PS used as an initial phase in allowing a consumer to procure a beverage dispensable from any of the dispensing modules Dn.

The initial phase of the process PS involves the consumer engaging in a point of sale (PPOS) transaction following selection of the holder device 25 which has the unique identifier stored in a read-only manner with its RFID chip 42. This unique identifier is already established and registered by the processor 10 as being in an ‘inactive’ state. This status of the unique identifier is represented by the characteristic which has at least two states: an ‘inactive’ state, and an ‘active’ state.

Once the holder device 25 is selected the consumer presents (at 50) the holder device 25 for purchase. The consumer also purchases a selected bottle 20 (of the volumetric capacity desired) that is compatible with the holder device 25. The consumer also purchases a desired type of beverage to be dispensed into the bottle 20 from any selected networked dispensing module Dn.

The holder device 25 and bottle 20 are therefore purchased by the consumer for use in the system 5 for the purpose of procuring the desired beverage from any of the networked dispensing modules Dn—which could either be a single transaction (eg. the first mode of operation), or for any number of future transactions (eg. the second mode of operation). In this manner, the holder device 25 and bottle 20 can remain with the consumer and reused for each subsequent transaction (for a further dispensing event). This is in contrast to the consumer purchasing packaged items in each subsequent transaction. Accordingly, reducing the demand for packaged items has the potential to reduce the related carbon footprint.

The consumer may be required to provide (at 55) their name and the necessary documentation to evidence their legal age for the purpose of verifying their legal eligibility to purchase the beverage. The means by which such age verification is performed could be manual, for example involving a relevant point of sales staff tasked with scrutiny of appropriate identification documentation, or could be conducted in a substantially automated or autonomous manner (using, for example, AI technology) in which the documentation is scrutinized digitally using any appropriate scanning/digitization (eg. identification card reader, image/photo scanner/reader devices) process(es) used for digitizing the requisite identifying information for use in making the required verification. The requisite age identification information is provided by the consumer in order to verify their eligibility to purchase the beverage in the first instance (ie. first mode of operation).

Completion of the purchase of the bottle 20 and the holder device 25 involves the initiation of a status change (at 60) in the processor 10 of the unique identifier of the holder device 25 on favourable determination that the consumer is age appropriate. In this manner, the processor 10 is informed of the status change from the PPOS focus—the status of the unique identifier of the holder device 25 then transitions from the default ‘non-active’ status, to an ‘active’ status. For the first dispensing event, this change in status of the unique identifier stored on the RFID chip 42 (as recorded or registered with the processor 10 as now being of an ‘active’ status) and notification of same facilitates authorising by the processor 10 of dispensing from any of the dispensing modules Dn in respect of the consumer when the bottle 20 and the holder device 25 (with the RFID chip 42) are presented at a selected dispensing module Dn. In substance, as this is the first time the status of the holder device 25 is ‘activated’, it is registered by the processor 10 that the holder device 25 is now authorised to undertake a first dispensing event from any of the dispensing modules Dn that the holder device 25 (and RFID chip 42) is presented to by the consumer.

The characteristic of the unique identifier may comprise an indication as to whether the consumer's request relates to the first dispensing event, or whether the consumer's request relates to a further dispensing event that is subsequent to the first dispensing event. For example, the characteristic of the unique identifier may indicate whether the consumer is, for example, a ‘first user’ (where, for example, the characteristic may indicate that the consumer is authorised by the processor 10 for undertaking only a single dispensing event from a selected dispensing module Dn), or a ‘long time’ or ‘ongoing’ user (where, for example, the characteristic indicates that the consumer is (or has been) authorised by the processor 10 for undertaking further dispensing event(s) from any selected dispensing module Dn). The characteristic of the unique identifier may also comprise an indication of a credit having been conferred to the consumer on completion of a payment transaction in respect of the first dispensing event.

Thus, on confirmation (at 60) of the change of status of the unique identifier of the holder device 25, the processor 10 is updated of the revised status, and, consequently, the updated status now available to all dispensing modules Dn for querying when required. In this manner, each dispenser module Dn will be able to learn of the revised ‘active’ status of a given holder device 25 (and the RFID chip 42) when presented by the consumer. On this confirmation, dispensing from the relevant dispensing module Dn is authorised.

It will be appreciated that scrutiny of the status of the unique identifier can be implemented in a number of ways. One implementation may involve each of the dispensing modules Dn being capable of querying the processor 10 at the time of reading/acknowledging the unique identifier of the RFID chip 42 when presented by the consumer. Another implementation may involve the processor 10 updating each of the dispensing modules Dn following the status change. Of course, the processor 10 could be configured so as to enable each of the latter methods as might be considered appropriate. Storing of status information for each unique identifier with the processor 10 lends itself to computing/communication efficiencies, which can include increased control of the security of such information. However, local storage of such information may provide for quicker response times which could improve consumer experience when interfacing with a dispensing module Dn. It would be appreciated that similar considerations also apply to consumer account information and the personal passcode data required to be confirmed/acknowledged at the dispensing module Dn. In one embodiment, less sensitive information could be cached local with/at the dispensing modules, and more sensitive information stored securely with the processor 10.

Process PS now involves the consumer interfacing with one of the dispensing modules Dn for dispensing of the earlier selected (and purchased) beverage type into the bottle 20. Presentation of the holder device 25 (with the RFID chip 42) and the bottle 20 to a desired dispensing module Dn, is confirmed by the dispensing module operating to read and acknowledge the RFID chip 42. The first dispensing event can then proceed. Further dispensing events sought by the consumer with the same holder device 25 (with respective RFID chip 42) will require the consumer to provide a second identifier which, in one form, can be provided in the form of a personal passcode or password (hereinafter, personal passcode—the creation of which is described further below) and a third identifier (if this level of verification is enabled as described further below) which associates with the consumer and which is used for use in an identity verification event.

The consumer presents (at 65) the holder device 25 (with RFID chip 42) and bottle 20 to a selected dispensing module Dn. The consumer presents the holder device 25 to the selected dispensing module Dn in a manner that allows the reader module DR,n of the relevant dispenser module to power up the RFID chip 42 (of holder device 25) and interact therewith for the purpose of reading (at 70) the unique identifier stored with the RFID chip 42 (of holder device 25). With the unique identifier known, the dispensing module Dn then seeks to determine whether this unique identifier is registered with the processor 10 as being in an ‘active’ state. Once it is determined that the unique identifier is of an ‘active’ status, dispensing of the first beverage can be then authorised. With the unique identifier known, it can be determined (by, for example, appropriate scrutiny as to whether the consumer has completed their account set-up by providing the requisite information, as discussed below) whether the consumer is a ‘first user’, and, if relevant, whether sufficient credit has been conferred. On presentation of the unique identifier at the relevant dispensing module Dn by the consumer, the consumer may be provided with a personalised greeting (for example, by way of relevant information displayed on a display screen or interface means for interfacing with the dispensing module Dn and or the processor 10). The unique identifier can be initially encrypted within the RFID chip 42 so that when the dispensing module Dn has the correct decryption key the unique identifier can be understood.

As noted above, once the first dispensing event is completed, further dispensing events with the same holder device 25 (and RFID chip 42) will require the consumer to provide the personal passcode (the creation of which serves as the second identifier as described further below) and a third-party passcode (if this level of verification is enabled, the creation of which serves as the third identifier as described further below) as the basis of a verification event. The processor 10 is configured operable to enable the verification event when the consumer presents at one of the dispensing modules Dn seeking to further procure beverages (for example, one or more refills) therefrom subsequent to the first dispensing event. In substance, the verification event is part of a second mode of operation of the system 5 and operates to verify the identity of the consumer with the processor 10 (via the relevant dispensing module Dn) when the consumer presents at any of the dispensing modules Dn for the purpose of seeking further procurement of a selected beverage. In the present embodiment, the verification event involves the second identifier for the purpose of verifying the identity of the consumer with the processor 10 when the second identifier (and the third identifier if this level of verification is enabled) is presented at the relevant dispensing module Dn in addition to the presentation of the unique identifier (ie. the RFID chip 42 and the bottle 20).

In some embodiments of the system 5, the consumer will be required to provide a third identifier at the dispensing module Dn for providing/enabling a further layer of verification of the consumer's identity (as will be discussed below). In some countries, regulatory requirements require robust/rigorous procedures to be enabled for ensuring that unconventional systems for procuring restricted items are as effective (or more effective) than existing point-of-sale purchasing practices involving human staff. In this regard, a necessity then exists to satisfy regulatory bodies to ensure that sufficient controls are enabled so as to eliminate (to the extent reasonably possible) the intervention of unlawful practices (which it is noted, can occur in point-of-sale environments involving human staff, but attract heavy penalties if such practices are identified). As will be described below, third party authentication services can be employed to provide a further means of confirming (thereby representing an enhanced level of security) the consumer's identity when (for example, when presenting at a selected dispensing module Dn when undertaking a further dispensing event, ie. the provision of the third identifier confirming that the actual consumer who completed the first dispensing event (as part of the first mode of operation) is the same consumer now seeking a further dispensing event (as part of the second mode of operation).

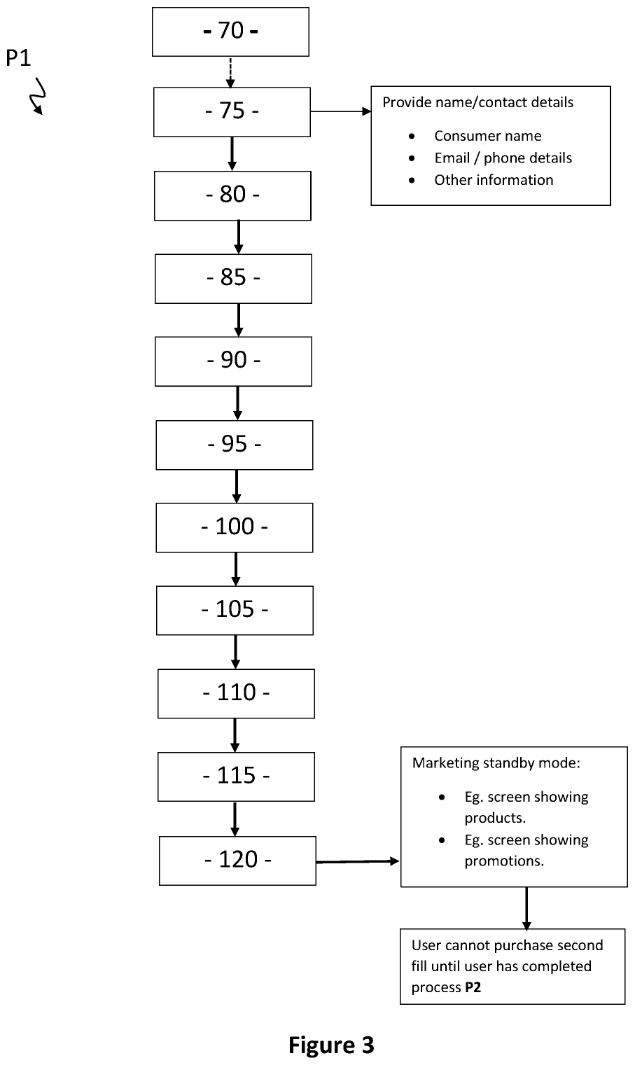

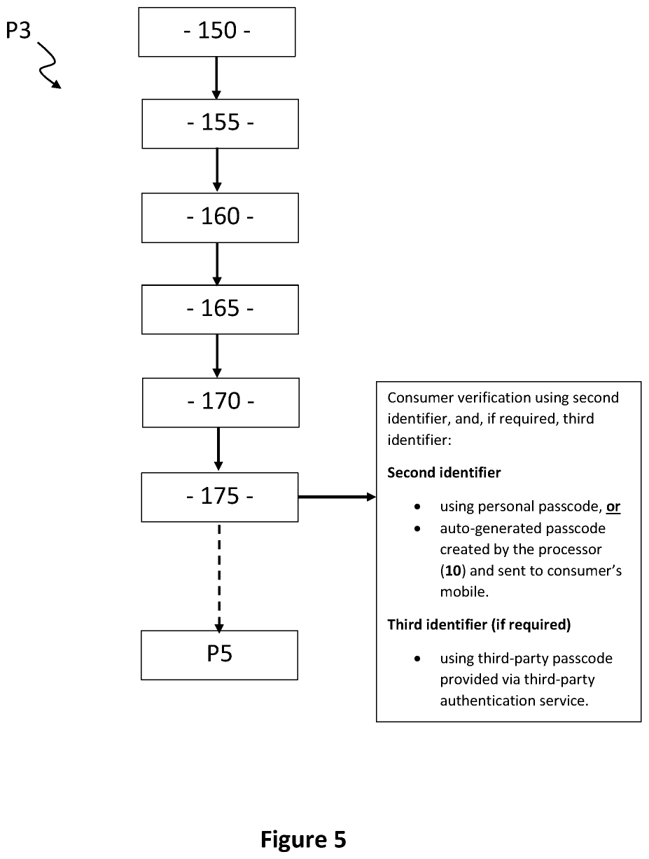

Once the legal age of the consumer is verified, the consumer can proceed in accordance with a number of possible options, shown in FIGS. 3 to 7 as processes P1-P5:
P1: continue to interface with the relevant dispensing module Dn for the dispensing of the pre-purchased selected beverage (see FIG. 3) therefrom—this being the first beverage dispensing event (in effect, the first mode of operation enabled by the processor 10);
P2: attend to completing the consumer's account or registration by providing requisite details/information of the consumer for storing in the processor 10 for further dispensing events—this process being a requirement for the consumer seeking ongoing engagement with the processor 10 in procuring further dispensing events (in effect, the second mode of operation enabled by the processor 10 referred to above);
P3: attend to applying credit to the consumer's account, from which credit for future dispensing events can be provided for avoiding the need to provide payment details at the dispensing module Dn for each future dispensing event;
P4: seeking dispensing of a selected beverage on the provision of payment details at the relevant dispensing module Dn.
P5: continue to interface with the relevant dispensing module Dn for the dispensing of a selected beverage following the application of credit to the consumer's account as undertaken in process P3 (see FIG. 5).

Process P1 for continuing to interface with the relevant dispensing module Dn for the dispensing of the first selected beverage is shown in FIG. 3.

Following completion of process PS (ie. following on from step 70), and using an interface means provided with the relevant dispensing module Dn, the consumer is enabled to enter (at 75) their name and contact details using the interface module (for example, a touchscreen or similar) provided at the dispensing module Dn. Provision of these details allows the consumer to be contacted by the processor 10 so that the consumer can establish and complete an account with the processor 10 for use in obtaining subsequent refills (ie. further dispensing events) of any selected beverage carried by any of the networked dispensing modules Dn.

The holder device 25 may be labelled with a certain type of beverage and the identifier may be permanently associated with that beverage type. In this case the consumer is not able to choose to use a different beverage to for the dispensing module to dispense into the bottle 20. Alternatively, the labelling of the holder device 25 may be generically labelled with respect to the beverage type and the consumer selects (at 80) the beverage type that he/she wishes to purchase (eg. a range of different alcoholic beverages may be provided) including by brand and product name. For example, on the dispensing module Dn recognizing the holder device 25 and its association with the consumer, the interface module of the dispensing module provides a welcome/greeting screen displaying the following consumer selection items:
Consumer requested to confirm that they are the owners of the holder device 25 and bottle 20—thereby confirming that they are the original consumer who has been prior verified for legal compliance purposes;
Consumer requested to confirm that the bottle 20 is clean and empty, and is in the holder device 25;
If the identifier is not currently associated with a beverage type, the consumer is requested to select, or if the identifier is currently associated with a beverage type confirm, the desired beverage (for example, gin, whisky/whiskey, vodka)—depending on what range of beverages are carried by the relevant dispensing module Dn;
If the identifier is not currently associated with a beverage volume, consumer is requested to confirm the volumetric size, for example, 700 ml or 1L (subsequent messaging could inform of correct bottle sizing) for dispensing.

On receipt of the selection(s), the relevant dispensing module Dn records the association of the identifier with the selected beverage type and/or volume.

The dispensing module Dn then actuates (at 85) the opening of an access door or panel (hereinafter, access door) to an otherwise access controlled dispensing region DD,n of the dispensing module—it will be appreciated that this could be performed following favorable recognition of the RFID chip 42. In response (at 90), the consumer inserts the holder device 25 (with the bottle 20 supported therein) which physically registers with a region of the access controlled dispensing region DD,n. In one form, registration between the holder device 25 and the access controlled dispensing region DD,n is by way of the base of the holder device 25, at about where the protrusion 40 is provided, providing a recessed region on its underside wall that registers with a complimentary shaped protrusion or similar formation provided on a surface of the access controlled dispensing region DD,n at which the holder device 25 will sit. In this manner, the recessed region 41 at the base of the holder device 25 receives the complimentary shaped protrusion/formation provided by the access controlled dispensing region DD,n thereby confirming the registration between both components. In this regard, registration between both components may take any number of different forms. The holder device 25 may be unable to register if the bottle 20 and/or the holder device 25 is not of the correct size and/or shape.

Following insertion/registration of the holder device 25 and the bottle 20 in the access controlled dispensing region DD,n of the relevant dispensing module Dn, the access door is caused to be closed (at 95).

With the access door closed, the relevant dispensing module Dn operates (at 100) so as to cause the dispensing of the selected beverage into the bottle 20.

Once dispensing is completed, the access door may be configured to remain closed. In this manner, if no credit exists in respect of the consumer's account (which can be enabled for further dispensing events described below), the interface module of the relevant dispensing module Dn may request payment be made for the type and volume of the beverage dispensed. If sufficient credit exists or the purchase has been pre-paid, this step can be bypassed.

Once the dispensing event is completed, or payment has been verified and accepted (if relevant as per above), the access door is again operated to open (at 105) so as to allow the consumer to remove (at 110) the now filled bottle 20 and supporting holder device 25. Once the now filled bottle 20 and supporting holder device 25 is removed, the access door is caused to be closed (at 115) thereby securing the access controlled dispensing region DD,n.

At this time the interface module may display to the consumer with any type of information that may relate to their account and/or transaction history. Further, an update of any carbon footprint impacts could also be displayed, for example. The skilled reader would appreciate that any information associated with the consumer (and or their transaction history) could be displayed by the interface module.

With the access door to the access controlled dispensing region DD,n closed and secured, the dispensing event is completed. At this time (at 120), the relevant dispensing module Dn is caused to revert to a standby state or mode, laying in await for the next dispensing event. When in the standby state or mode, the dispensing module Dn may be caused to operate, via its interface module/display screen or similar, a predetermined promotional program showing any of a variety of marketing material. In an embodiment, when in standby mode, all beverage lines are in a fail-safe mode (in a position where if power was removed that no configuration of values, tanks etc. could remain open and cause a potential release). In addition, un-necessary systems that initiate heat or require electrical sources would be made dormant to eliminating any ignition source. Necessary systems like the processor (that can be conducting system upgrades, system/operational diagnostics checking in the dispensing module etc), the RFID reader and the promotional interface may remain operational. Extra safety features, including purging of the air in the dispensing module, may continue. This is a safe dormant status.

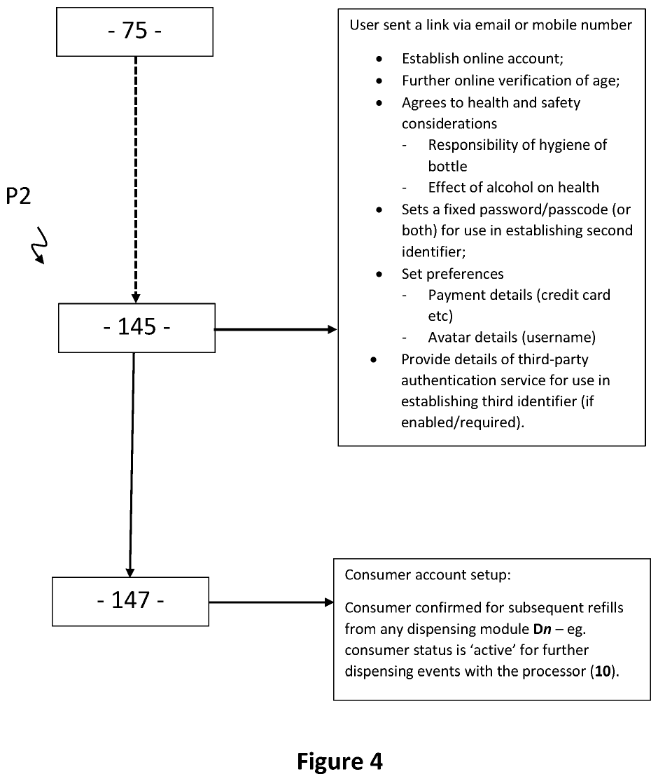

Process P2 for attending to completing the consumer's account or registration by providing details/information of the consumer for storing in the processor 10 for further dispensing events is shown in FIG. 4, and flows from process P1 where the consumer's contact details are taken (at 75). Using any of the contact information provided by the consumer, the processor 10 contacts the consumer, for example, by sending the consumer a link (at 145) to an online website/page allowing the consumer to provide the requisite information. At this stage, the consumer may engage with the process and provide the requisite information for setting up their account with the processor 10, or simply opt not to.

For procuring further dispensing events, the consumer may be required by the processor 10 to provide requisite information in the event the consumer wishes to undertake further dispensing events beyond that of the first dispensing event. The second identifier can be created or generated by the consumer (for example, the personal passcode referred to earlier). Alternatively, the consumer may request or elect for the processor 10 to provide (create or generate) the second identifier, which is then communicated (using for example, any appropriate communication means, such as an email, and or a short message service (SMS) broadcast) to the consumer for presentation at the relevant dispensing module Dn when procuring their next dispensing event. In both scenarios, the second identifier is associated with the consumer for use in verifying the identity of the consumer with the processor 10 and therefore, by way of the consumer having provided the requisite information, providing an indication of the consumer being authorised to procure another beverage from any of the dispensing modules Dn subsequent to the first dispensing event. Any of the requisite information to be provided by the consumer can provide basis for the second identifier.

As noted above, in addition to providing the second identifier, the consumer may be prompted to provide a third identifier that is generated independent of the consumer and the system 5 (provided, in at least one embodiment, in the form of a passcode; hereinafter, third-party passcode) that operates to provide a further level of verification of the consumer's identity—this additional ‘layer’ of verification serving to further confirm that the consumer presenting at a dispensing module Dn for a further dispensing event is the same consumer who undertook a first dispensing event and provided the requisite information for completing their account with the processor 10. The third-party passcode is generated independent of the processor 10 and the consumer and is required regardless of whether the second identifier is the consumer's own personal passcode or the auto generated passcode.

In one form, the third-party passcode is generated by a third-party authentication service (ie. an entity independent of the consumer and the processor 10) and made available to both the processor 10 and the consumer by independent methods. In one practical implementation, the consumer must be present at the relevant dispensing module Dn with their portable device (eg. smart phone)—the portable device being the means by which the third-party passcode is made available to the consumer by the third-party authentication service. In order to be provided with the third-party passcode, the consumer must be subscribed to a third-party authentication service, such as for example, “Authy” or “Google Authenticator”—it will be appreciated that alternatives to these examples exist. The third-party authentication service generates the third-party passcode at regular intervals on a substantially continuous basis. The third-party passcode is uniquely associated with the consumer (the third-party passcode is user specific and never the same for another consumer subscribed to the third-party authentication service). Generation of such a third-party passcode every 30 seconds is common for many third-party authentication services, but such interval could be readily varied as might be required for a given circumstance, eg. the interval could be uniform or non-uniform as required. Once generated, the third-party passcode remains valid for a predetermined period of time—before then being regenerated and remaining valid for the subsequent period of time. The third-party authentication service is set up with the processor 10 so that the service can communicate or ‘synchronise’ with the processor 10 so that the system 5 is able to be made aware of—independent of the consumer—the third-party passcode that is currently valid for the consumer. The consumer is made aware of ‘their’ currently valid third-party passcode by way of the third-party authentication software application installed on their portable device (which is synchronized with the computing network that is enabling the service).

Use of such third-party authentication service can be beneficial as activity relating to the consumer and their use of third-party passcodes generated by the service is often logged for audit purposes—denial of operation of such logging functionality by the consumer can present problems/difficulties for the consumer and their ongoing use of the processor 10 (thereby serving as a disincentive for engaging in improper practices involving the third-party passcode). Some dispensing modules Dn may be provided with camera technology (which may include image processing technology and or operable with AI technology) which can assist in confirming the physical presence of the consumer (for example, when operating the second mode of operation the dispensing modules Dn may take still images of the consumer undertaking each dispensing event, ie. the processor 10 recording/archiving a still image for each dispensing event for subsequent scrutiny if required). Integrated image processing and AI technology may provide monitoring/surveillance of dispensing events allowing improper use to be detected (and potentially acted upon) and advised of in or close to real-time.

The consumer provides details of their third-party authentication account as part of the setup of their account with the system 5. Provision of the relevant details of the consumer's third-party authentication service allows the processor 10 to ‘synchronise’ with the relevant service so as to access the current valid third-party passcode that the service has generated and associated with the consumer. Where the consumer already has a subscription to a third-party authentication service, they only need to provide the relevant account details for the service to the processor 10 when setting up their account with the system 5. If the consumer is not already subscribed to an existing third-party authentication service, they will be prompted by the processor 10 to subscribe to such a service during the setup of their account. In this regard, the processor 10 may present a number of options of authentication services allowing the consumer to select and subscribe to a service of their choosing. The processor 10 may enable the consumer to complete a subscription process with a selected authentication service as an embedded process while they complete the setup of their account. In another embodiment, the processor 10 may pause the account setup process until the consumer is able to provide the required details of their selected authentication service—thereby allowing the consumer to subscribe to their selected authentication service outside of the account setup process (with the processor 10). In such an instance, the processor 10 will not authorise the consumer to be able to undertake further dispensing events until the details of the selected authentication service have been provided to the processor 10.

Once the consumer's account is completed, the consumer is confirmed or authorised (at 147) within the processor 10 as being approved for further dispensing events from any of the networked dispensing modules Dn.

In one practical implementation, the second identifier may be associated with a characteristic (like with the characteristic of the unique identifier of the authentication event) that indicates that the consumer is approved/authorised for undertaking further dispensing events from any of the dispensing modules Dn (ie. the characteristic associated with the second identifier thereby defined or initiated on the consumer providing the requisite information used in defining the second identifier). In another possible implementation, the characteristic of the unique identifier may be modified or updated to indicate that the consumer is ‘active’ and that the consumer is recorded with the processor 10 as being authorised as being an ‘on-going’ user and therefore approved/authorised to undertake further dispensing events.

Details sought by the processor 10 can comprise: the consumer's name, age, phone number, email address, physical address, credit card details, further information for verification of the consumer's age, consumer generated personal passcode for identification/verification purposes, agreement by the consumer to one or more terms or conditions required for the on-going procurement of the restricted/controlled beverages (agreement to health and safety considerations), responsibility for hygiene of the bottle(s) purchased by the consumer, understanding of the effects of alcohol on health, electing to receive a mobile code (for example, the auto-generate passcode) (possibly in addition to setting the personal passcode), setting/election of preferences such as payment details (credit card, etc), nickname/avatar details, details of a third party authentication service preferred by the consumer for providing the third identifier (ie. third-party passcode) so that the processor 10 is able to ‘synchronise’ with the third-party authentication service in operating to verify the identity the consumer when undertaking a further dispensing event (in one form, the consumer will be prompted during the account set-up process (at 145) to open an account with an appropriate third party authentication service if they are not already subscribed to one). Such information could be provided by way of the interface module provided with a respective dispensing module Dn, or by way of a suitable computing system (desktop computer, portable electronic device, etc) that enables the consumer to access the processor 10.

It will be appreciated that any of the information provided by the consumer can be used as verification events to be used in further dispensing events at any of the dispensing modules Dn, favourable resolution of which is by way of a determination being made of the accuracy of the relevant information once provided by the consumer at the relevant dispensing module Dn and verified with the processor 10 (ie. by way of the communicative relationship between the relevant dispensing module Dn and the processor 10—via the cloud-based network/system 15).

Process P3 for attending to applying credit to the consumer's account, from which credit future dispensing events can be funded for avoiding the need to provide payment details at a dispensing module Dn, is shown in FIG. 5.

Process P3 begins (at 150) where the consumer logs onto their account enabled by the processor 10. The consumer then selects (at 155) a beverage (and, if necessary, the desired size/volume) that they wish to purchase from those available with the relevant dispensing module (Dn). The processor 10 then prompts for payment (at 160) of the beverage using any of a number of appropriate payment options (for example, credit card, PayPal details). Confirmation of pre-payment of the beverage is acknowledged by the processor 10 and available for interrogation by any of the networked dispensing modules Dn. It will be appreciated that knowledge of pre-payment could be affirmatively transmitted to each of the dispensing modules Dn for storage until the consumer presents to one of the dispensing modules Dn, or could be queried by the relevant dispensing module Dn at the time dispensing is sought. Relevantly, however, dispensing of the pre-purchased beverage is not authorised until such information is received by the relevant dispensing module Dn.

Once payment is completed (at 160), the consumer is then able to present using their holder device 25 and the bottle 20 at any of the networked dispensing modules Dn for dispensing of the pre-purchased beverage. The process of receiving the dispensed beverage from a dispensing module Dn is similar to that has been described above. However, for the case of the consumer wishing to seek further refills from any of the dispensing modules Dn, the consumer is required to complete their account with the processor 10, involving the provision of various requisite information. As discussed above, completion of provision of this information establishes basis for the second identifier that is associated with the consumer (and, indeed, the third identifier if the further level of identity verification is required) operating to provide an indication of the consumer as being of an ‘active’ status and able to access further refills of selected beverage(s) from any of the dispensing modules Dn. As noted, the second identifier can be provided in the form of the consumer's personal passcode that is created or generated by the consumer, or could be the auto-generated passcode generated by the processor 10 (on request/election by the consumer), and sent to the consumer for use at any of the dispensing modules Dn.

Thus, in continuing the process P3, the consumer presents at a dispensing module Dn (at 165) and places the holder device 25 (and the bottle 20) in a manner allowing the dispensing module Dn to read (at 170) the unique identifier stored with the RFID chip 42 (of the holder device 25). Once the RFID chip 42 is read and the unique identifier known, the dispensing module Dn operates to determine/confirm that the identifier is ‘active’. Once the ‘active’ status of the unique identifier of the RFID chip 42 (of the holder device 25) is confirmed, the consumer then enters (at 175), using the interface module provided with the relevant dispensing module Dn, the second identifier, ie. their personal passcode, or, alternatively, the auto-generated passcode sent to their mobile device from the processor 10, as well as the third identifier (if this level of verification is enabled). Similar steps as described above in relation to step 80 of P1 may then follow.

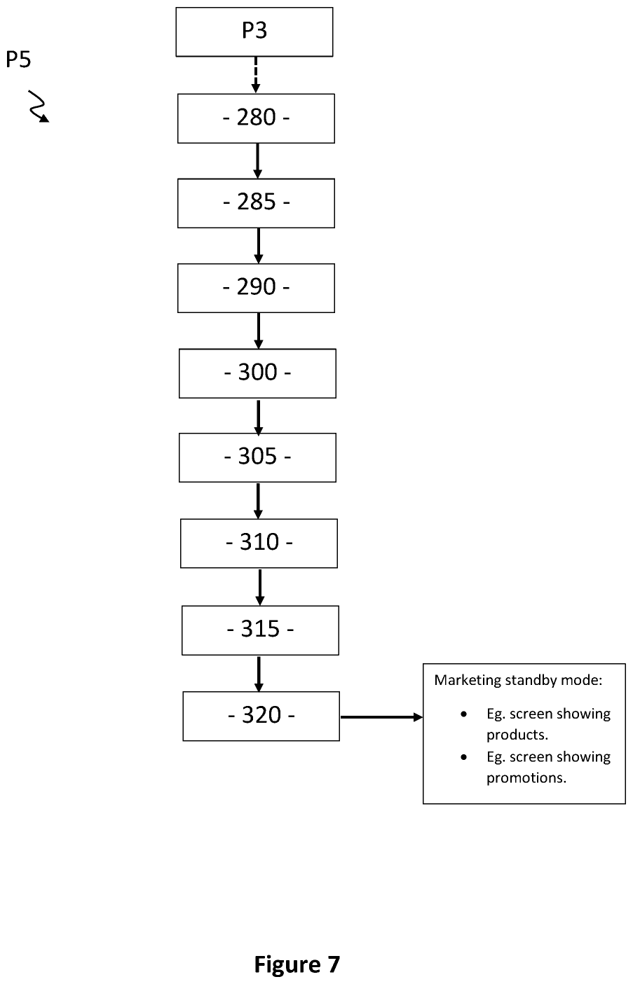

On the relevant dispensing module Dn determining the ‘active’ status of the unique identifier of the RFID chip 42 (of the holder device 25) and successfully verifying the second identifier (ie. the consumer's personal passcode or the auto-generated passcode) so as to verify the identity of the consumer, and, if required, successfully verifying the third identifier (if this level of verification is enabled), access allowing the consumer to enter the holder device 25 and the bottle 20 into the access controlled dispensing region DD,n of the relevant dispensing module Dn is permitted, as provided by way of process P5 (shown in FIG. 7), and a dispensing event undertaken (to be discussed below).

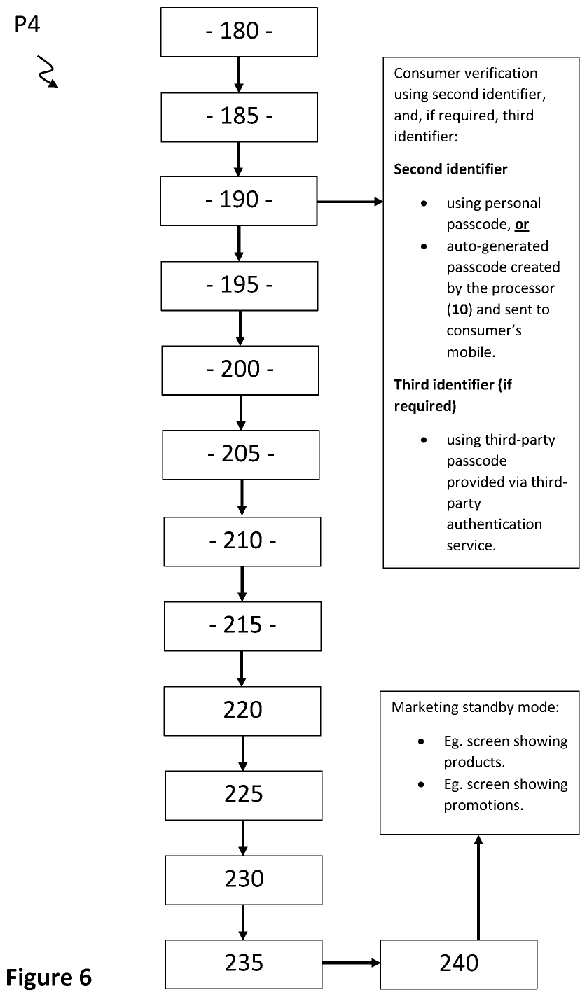

Process P4 used for seeking dispensing of a selected beverage on the provision of payment details in-store at the relevant dispensing module Dn is shown in FIG. 6.

Process P4 begins (at 180) where a consumer presents with the holder device 25 (and the bottle 20) at a desired dispensing module Dn and places the holder device 25 (and the bottle 20) in a manner allowing the dispensing module Dn to read (at 185) the unique identifier stored with the RFID chip 42 (of the holder device 25). Once the RFID chip 42 is read and the unique identifier known, the dispensing module Dn operates to determine/confirm that the unique identifier is ‘active’. Once the ‘active’ status of the unique identifier of the RFID chip 42 (of the holder device 25) is confirmed, the consumer then enters (at 190), using the interface provided with the relevant dispensing module Dn, the second identifier, ie. their personal passcode, or, alternatively, the auto-generated passcode sent to their mobile device from the processor 10, as well as the third identifier (if this level of verification is enabled). Similar steps as described above in relation to step 80 of the process P1 may then follow.

On the relevant dispensing module Dn determining the ‘active’ status of the unique identifier of the RFID chip 42 (of the holder device 25) successfully verifying the second identifier (ie. the consumers personal passcode or the auto-generated passcode) so as to verify the identity of the consumer, and, if required, successfully verifying the third identifier (if this level of verification is enabled) is confirmed, the consumer is then prompted to select (at 195) the beverage they wish to purchase. Once the beverage is selected, the relevant dispensing module Dn then prompts the consumer for payment (at 200) of the beverage using appropriate payment options (for example, credit card, or PayPal details).

The relevant dispenser module Dn actuates (at 205) the opening of an access door to an otherwise access controlled dispensing region DD,n of the relevant dispenser module. In response, the consumer inserts (at 210) for physical registration purposes, as described above in relation to step 90 of P1, the holder device 25 with the bottle 20 supported therein, following which the access door is caused to be closed (at 215).

In an embodiment, where the dispensing module Dn has different dispensing regions DD,n for different types of item to be dispensed, then the identification may be used to determine which type of item (eg. gin) is recorded in association with the identifier and the respective dispensing region DD,n opened to allow to allow the holder device 25 to be inserted so as to receive that type of item (gin) as oppose to other types of item (eg. vodka, whisky etc) from the other dispensing regions DD,n.

Where the dispensing module Dn has a dispensing region DD,n that is able to dispense multiple types of item, the dispensing module Dn will need to know which type of item to dispense. When the identifier is associated with a type of item, this can be used to select which item the dispensing module Dn is to dispense. Other selection methods are possible, such as the consumer manual entering the type.

In an embodiment, the dispensing region DD,n is configured operable to make safe from volatiles/flammables before, during and/or after dispensing. Preferably the configuration to make safe comprises ventilation, cooling and/or rinsing, preferably with water. When dispensing spirits, which commonly have alcohol by volume of 40% and a 26 degree C. flashpoint, regulation commonly requires management of ignition sources, and having adequate ventilation and cooling so that the ambient temperature is below 26 degrees C.

Management of ignition source and ventilation may comprise:
a) Eliminate electrical sources from product
b) Isolate heat sources from product
c) Purge electrical areas
d) Purge areas where vapours can build up
e) Adequate closed loop spills systems
f) Low power electronic systems in areas of product
g) Fail safe mode/standby mode when not in operation to ensure no tampering of devise will lead to a spill and therefore a dangerous environment.

With the access door closed, the dispenser module Dn then may transition into an operational mode and operates (at 220) to cause the dispensing the appropriate amount of the selected beverage into the bottle 20. In operational mode, the dispensing module Dn transitions from standby mode (described above). This may include re-instantiating operating systems in order to facilitate the correct operation of the dispensing module Dn. This includes, but is not limited to, forced purging of systems to ensure no volatile beverage vapours exist in the dispensing module Dn while it has been in standby mode.

Once the dispensing event is completed, the access door is again operated (at 225) so as to allow the consumer to remove (at 230) the now filled bottle 20 and supporting holder device 25. Once the filled bottle 20 and supporting holder device 25 is removed, the access door is caused (at 235) to be closed thereby securing the access controlled dispensing region DD,n.

At this time the interface module may display to the consumer with any type of information that may relate to their account and/or transaction history. Further, an update of any carbon footprint impacts could also be displayed, for example. The skilled reader would appreciate that any information associated with the consumer (and or their transaction history) could be displayed by the interface module.

With the access door to the access controlled dispensing region DD,n closed and secured, the dispensing event is completed. At this time (at 240), the relevant dispensing module Dn is caused to revert to a standby state or mode, laying in await for the next dispensing event. When in the standby state or mode, the dispensing module Dn may be caused to operate, via its interface module/display screen or similar, a predetermined promotional program showing any of a variety of marketing material.

Process P5 for continuing to interface with the relevant dispensing module Dn for the dispensing of a selected beverage following the application of credit to the consumer's account, as undertaken in process P3, is shown in FIG. 7.

Following the completion of process P3 the relevant dispensing module Dn (at 280) actuates the opening of the access door to the otherwise access controlled dispensing region DD,n of the dispenser module Dn. In response, the consumer inserts (at 285), for physical registration purposes as described above in relation to step 90 of P1, the holder device 25 with the bottle 20 supported therein, following which the access door is caused to be closed (at 290).

With the access door closed, the dispensing module Dn operates so as to cause dispensing (at 300) of the selected beverage into the bottle 20.

Once the dispensing event is completed, the access door to the access controlled dispensing region DD,n is again operated (at 305) so as to allow the consumer to remove (at 310) the now filled bottle 20 and supporting holder device 25. Once the filled bottle 20 and supporting holder device 25 is removed, the access door is caused (at 315) to be closed thereby securing the access controlled dispensing region DD,n.

At this time the interface module may display to the consumer with any type of information that may relate to their account and/or transaction history. Further, an update of any carbon footprint impacts could also be displayed, for example. The skilled reader would appreciate that any information associated with the consumer (and or their transaction history) could be displayed by the interface module.

With the access door to the access controlled dispensing region DD,n closed and secured, the dispensing event is completed. At this time, the dispensing module Dn is caused to revert to a standby state or mode (at 320), or mode awaiting the next dispensing event as described above. When in the standby state or mode, the dispensing module Dn may be caused to operate, via its interface module/display screen or similar, a predetermined promotional program showing any of a variety of marketing material.

Each of the processes described herein outline an affirmative flow through the relevant stages. At any stage an adverse or negative outcome could arise that serves to disrupt the process. In such instances, the processor 10 or the dispensing module Dn enables, by way of an appropriate interface module, actions or options that could cease further advancement in the process, or seek to correct any deficiency that gave rise to the disruption. For example, failure of any of the required authentication component (a RFID chip presented that is not registered as ‘active’ by the processor 10 by the relevant dispensing module, and or an incorrect personal or auto-generated passcode being supplied/provided by the consumer at the relevant dispensing module Dn) would necessarily disrupt the process. In such instances, appropriate information notices are provided to the consumer for the purposes of resolving the relevant conflict, either at the dispensing module Dn itself, or by way of the processor 10 via an appropriate form of communication (for example, using a portable electronic device accessible with the internet and or an appropriate communication service for receiving a SMS broadcast).

The processor 10 may be enabled by way of a processor module PM (refer FIG. 1). The processor module PM may be configured so as to be capable of receiving one or more signals (for example, from an electronic device (portable of otherwise, and which could be operable by way of a consumer or having been suitably programmed by a consumer) such as a control station, a tablet device, mobile phone, remote transmitting device and the like. A signal could also be transmitted by the electronic device causing or implementing any type of operational event to occur. Thus, the processor module PM could be operable with a communication module (not shown) so that control signals/commands can be received from the electronic device. Such an electronic device could communicate with the processor module PM using sufficiently equipped near field communication (NFC). Any other wireless protocol could also be used.

The processor module PM may be configured for controlling or managing all operations of the system 5 during use, independently or with input from the electronic device. The processor module PM may comprise a processor which could include one or more cores that may enhance speed and performance of a multiprocessor. In some embodiments, such a processor may be a dual core processor, quad core processors, other chip-level multiprocessor and the like that combine two or more independent cores.

The operations conducted by the processor module PM may be by way of an appropriate computing system including one or more computing devices. In particular, the methods/processes described herein may be implemented as a computer application, computer service, computer API, computer library, and/or other computer program product. Any such computing system could include a logic subsystem and a data-holding subsystem. The computing system may optionally include a display subsystem, communication subsystem, and/or other components. Such a computing system may also optionally include one or more consumer input devices such as keyboards, keypads, mice, game controllers, cameras, microphones, and/or touch screens, for example. One or more logic subsystems may include one or more physical devices configured to execute one or more instructions. For example, any such logic subsystem may be configured to execute one or more instructions that are part of one or more applications, services, programs, routines, libraries, objects, components, data structures, or other logical constructs that could be operated by the electronic device and or the processor module PM. Such instructions may be implemented to perform a task, implement a data type, transform the state of one or more on-board devices (of the host vehicle), or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more on-board devices, which may be remotely located and/or configured for coordinated processing. One or more aspects of the logic subsystem may be virtualized and executed by remotely accessible networked computing devices configured in a cloud-based (15) computing configuration.

The processor module PM may comprise various forms of data-holding systems for the storage of relevant and/or software instructions. Such data-holding systems (and/or related subsystems) may include one or more physical, non-transitory, devices configured to hold data and/or instructions executable by the logic subsystem to implement embodiments of the methods/processes described herein.

Data-holding subsystems may include removable media and/or built-in devices. Data-holding subsystems may include optical memory devices (e.g., CD, DVD, HD-DVD, Blu-Ray Disc, etc.), semiconductor memory devices (e.g., RAM, EPROM, EEPROM, solid state storage, etc.) and/or magnetic memory devices (e.g., hard disk drive, floppy disk drive, tape drive, MRAM, etc.), among others. Data-holding subsystems may include devices with one or more of the following characteristics: volatile, nonvolatile, dynamic, static, read/write, read-only, random access, sequential access, location addressable, file addressable, and content addressable. In some embodiments, logic subsystems and data-holding subsystems may be integrated into one or more common devices, such as an application specific integrated circuit or a system on a chip.

Software or program instructions operated by the processor module PM may be associated (directly or indirectly) with a client (operable, for example, for transferring instructions to the processor module PM) that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client. The client may provide an interface to other devices including, without limitation, servers, cloud servers, other clients, printers, database servers, print servers, file servers, communication servers, distributed servers and the like. Additionally, this coupling and/or connection may facilitate remote execution of one or more programs across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In such implementations, remote repositories may act as a storage medium for program code, instructions, and programs.

Of course, similarly functionality as described above is also relevant to the control electronics of each of the respective dispensing modules Dn, ie. as shown in FIG. 1, each of the dispensing modules Dn, comprise respective processor or control modules DP,n for enabling control/operation of the functions to be carried out by the relevant dispensing module Dn, respective communication modules DC,n for enabling communication with the processor 10, respective (RFID) reader modules DR,n for enabling reading of the RFID chip 42 associated with the holder device 25, and respective access controlled dispensing regions DD,n for enabling dispensing of the selected beverage.

As noted, the holder device 25 and the bottle 20 are designed to be compatible with each of the networked dispensing modules Dn in the system 5. In this manner, the holder device 25 and the bottle 20 combination can only be used for dispensing purposes as part of the system 5. Individual bottles 20 may be configured so as to hold any specific volume of beverage, for example, 700 ml and 1 litre quantities (of course, other volumes may be provided for). For compatibility with the dispensing modules Dn, the holder device 25 may be configured so as to operate with bottles having different volumetric capacities. In achieving such compatibility between bottles of different volumetric capacity, respective dimensions of a height of the holder device 25 and a bottle 20 (regardless of the volumetric capacity of the bottle) are configured so as to be substantially the same, whereby the respective diameters of the holder device 25 and the bottle 20 are variable as appropriate so as to accommodate different volumes of the dispensed beverage. For example, respective heights of a holder device 25 and bottle 20 configured for holding a first volumetric capacity (for example, 700 ml) is substantially the same as the respective heights of a holder device 25 and bottle 20 configured for holding a second volumetric capacity (for example, 1 litre). In this manner, a standardised height of the holder device/bottle can be commensurate with a dimension of a means for receiving (an entry region to a portion of a dispensing module Dn that is operable for dispensing a selected beverage) the holder device/bottle at any of the dispensing modules Dn in the network.

Bottle 20 designs can be configured (shaped, designed) so as to be used with a specific type of beverage carried by/dispensed from any of the dispensing modules Dn. In this manner, a consumer may purchase a number of bottles 20 with each being intended for use with a specific type of beverage carried by the dispensing modules Dn, whereby each of the respective holder devices 25 can be attached or linked to the consumer's account, via association with the identifier of the respective holder device 25, so as to allow each of the holder devices 25 (with respective bottle 20) to be used at any of the networked dispensing modules Dn depending on which type of beverage the consumer wishes to be dispensed. Furthermore, holder devices 25 configured for use with a specific bottle volumetric capacity can be interchangeable with bottles of like volumetric capacity where each bottle is configured for use with a specific type of beverage. The volumetric capacity can be stored in association with the identifier of the holder device 25 such that the dispensing module Dn is able to determine the volume the bottle 20 is able to hold in order to dispense the appropriate about of beverage. In this manner, for example, a device holder 25 for use with bottles 20 having a 700 ml volumetric capacity can be used with any 700 ml capable bottle regardless of which type of beverage the bottle 20 is configured for use with. Thus, a consumer having a first 700 ml bottle configured for specific use with vodka, and second 700 ml bottle configured for use with gin, can procure refills of both bottles using the same holder device 25.

The holder device 25 may be made of a material that operates to protect the bottle 20. Advantages may be realised in that the bottle 20 wall thickness can be reduced as the holder device 25 works to protect the bottle (eg. less energy in manufacturing leading to lower carbon footprint and use of natural resources). Further, the holder device 25 provides the additional weight that reflects, for example, a perception of quality even when the bottle 20 is reduced in weight from reduced glass wall thickness. The material used to form the holder device 25 can vary depending on the marketing of the individual beverage type. The system 5 described herein can operate to assist in reducing setup costs for new bottling, labelling, and packaging.

Embodiments of the system 5 described herein may enjoy any of a multitude of advantages, notably that items of controlled or restricted access (eg. involving legal age constraints) can be conveniently vended to consumers of compliant standing (eg. being of appropriate age) at remote locations once sufficient age verification has been successfully conducted. Additionally, use of the holder device 25 and bottle 20 in a reusable manner can operate to reduce the generation of packaging material which ordinarily is disposed of following purchase. Environmental benefits may also flow from the principles described herein. For example, the principles described herein may allow for a significant reduction of the spirits industries reliance on single use containers, packaging and intensive shipping, and which could achieve a significant shift in the way such products are purchase by consumers. Without being bound by research to date, embodiments of the principles described herein have the potential to eliminate globally in the order of 2.3 million tonnes of CO₂ emissions, remove up to 4 billion bottles from manufacturing circulation, reduce energy requirements for manufacturing by around 10 thousand GWh. Such results could reflect a significant cost saving each year across the industry.

Furthermore, embodiments of the principles described herein may operate to reduce the risk of fraudulent practices in the procurement of regulated products in that the interaction of the system 5 with the first, second, third identifiers, the dispenser modules Dn, and the system 5 also having access to the identity details of the consumer (the consumer also being custodian of the holder device(s) 25 and the bottle(s) 20); the overarching architecture of the system serving to provide a robust and secure procurement system (bearing in mind that supply of the regulated products is controlled generally by the product supplier).

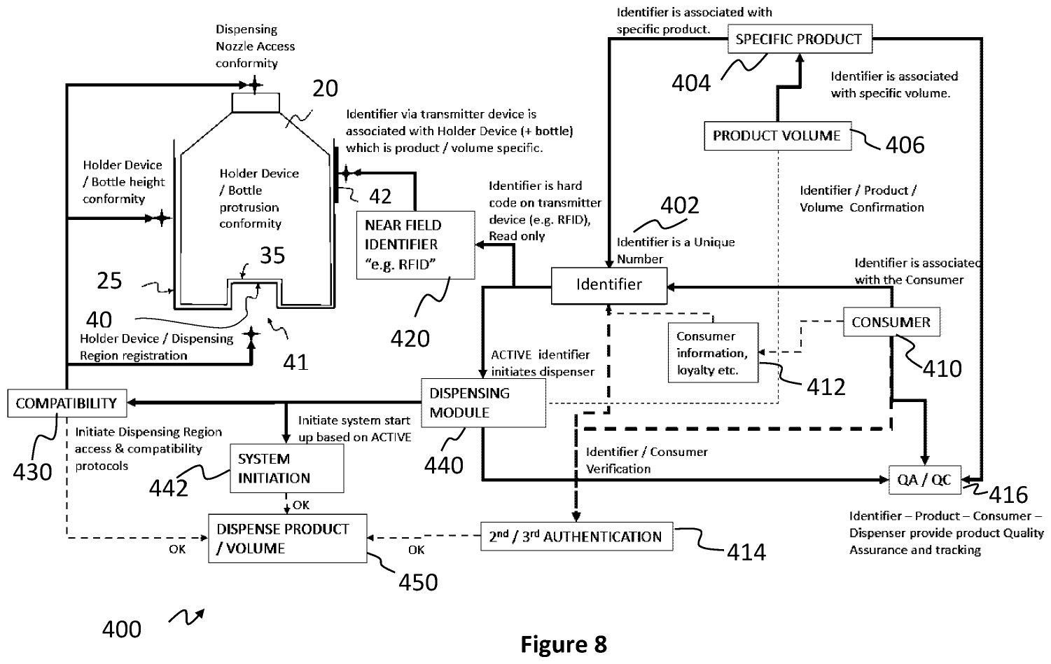

Referring to FIG. 8, a schematic diagram of one embodiment of a process 400 of dispensing a volume of an alcoholic beverage is described. In this embodiment the identifier 402 is a unique number stored 420 in a nearfield/RFID device 42 physically located on a holder device 25 for holding a bottle 20. There is a physical registration, for example, in the form of a protrusion 40 in the holder device 25 and a recess 35 in the bottle 20.

The identifier 402 is associated with a specific product type 404. This may involve the product type 404 being stored in the device 42 and/or elsewhere in the system 5. The identifier 402 is preferably also associated with a specific volume 406, which corresponds to the volume the bottle 20 should hold.

The identity of the consumer 410 is also stored in association with the identifier 402 for purposes of ensuring the consumer is permitted to be dispensed the beverage. Other information 412 regarding the consumer, for example for loyalty points can also be stored in relation to the identifier 402. The identifier 402 can be used for quality assurance/quality checking purposes to track the consumer 410 in relation to quality issues with the product.

When the consumer 410 with the holder device 25 holding the bottle 20 approaches a dispensing module 440 it can scan/read the RFID device 42 and determine the identifier 402. As discussed above, if the identifier is ‘active’ then the dispensing module may open the access door to receive the holder device 25. Other checks may also be performed, such as that the dispensing module 440 is able to dispense the specific product type 404 associated with the identifier. For instance, the dispensing module 440 may not be able to dispense the type of product that the identifier is associated with, or the dispensing module 440 may be out of the type of product.

A compatibility check 430 can be performed by the dispensing module 440, including for example checking that the profile of the recess region 41 is correct, that the holder device 25 and/or bottle are of the correct height so that the dispensing nozzle can be lowered into and engage correctly with the bottle opening.

The dispensing module 440 may also perform a system initiation check 442 to ensure it is in working order. This may include checking that the make safe operation is performed and if so to transition from standby mode to operation mode.

Additionally, if the second and if appropriate third identifications are required, they can be requested and checked in authentication step 414. This step may occur before system initiation check 442 step is initiated.

When the checks are completed affirmatively the product of the required volume can be dispensed at 450.

In a further application of the principles described herein, and as foreshadowed above, it will be appreciated that the controlled/restricted items could comprise pharmaceutical medicaments, either of solid, gel, or liquid composition (hereinafter, medicaments), and that could be dispensed by way of an appropriate dispensing event, such as for example, by way of an appropriately configured dispensing module or distribution point (which may involve a human interface component) in accordance with the principles described herein.

Accordingly, the principles of the system described herein could be applied for use in providing a system operable by a healthcare provider where medicaments prescribed by an appropriately qualified medical professional or healthcare provider (for example, following a standard medical consult that is either at the medical professional's premises or via a form of media interface, for example, video conference across the internet or other data communications network) can be collected from a distribution point as part of a dispensing event involving (for example, from an appropriately configured dispensing module or human interface) by a patient for whom the medicaments have been prescribed for use.

Broadly, in one form of such application, the patient's medical practitioner enables the patient to be registered during the medical consult (alternatively, the patient may register in advance with their medical practitioner or healthcare provider). During this registration stage, all the relevant details of the patient are recorded in the system (at least the details needed to receive the initial prescription), which may include provision of the first identifier in a form suited to the application—for example, the first identifier could be provided with a RFID card, or associated with a device/receptacle that is configured for holding or containing the medicaments when dispensed from the dispensing module or distribution point but which also serves as a storage means (for the medicaments). Alternatively, the first identifier, in either of the latter forms, may be provided (for example, sold, or rented/leased to the patient) by the healthcare provider or other party that is operable with the system, such as for example, a pharmacy that is associated with the healthcare provider or medical professional. In this manner, the patient can receive their prescribed medicaments from a dispensing module (or distribution point) operable with the system following the consult—this initial dispensing of the first prescribed medicaments is analogous to the first mode of operation as described above. The type of medicament can be associated with the identifier and used by the dispensing module to determine which and/or how much medicament to dispense.

In one implementation, following prescription of the medicament during the medical consult, the medical practitioner sets in motion a process which results in the medicaments being supplied to a dispensing module or distribution point for collection by the patient; a dispensing module or distribution point, for example, that might be located on or near the premises of where the medical consult occurred. As such, the patient is able to present to the dispensing module (or distribution point) to collect their prescription medicaments. For example, the medical practitioner logs the relevant details of the prescription (including information on the medication, the dosage and any relevant warnings) in the system and completes any necessary approval process to enter/confirm the prescription process. Once the details of the prescription are entered/approved in the system (including preferably association of the type and quantity of the medicament with the identifier of the receptacle into which the medicament(s) are to be dispensed), they are made available to a selected medicament supplier (for example, a selected pharmacy or similar provider of pharmaceuticals) who is then tasked with supplying the desired medicaments so as to make them available at a dispensing module (or the distribution point) that is operable with the system. Once the dispensing module (or distribution point) has been stocked with the prescribed medicament, the patient will be advised so that they can then proceed to present at the relevant dispensing module (or distribution point) for collection purposes (which could be at any time (24/7)).

The identifier not only serves to identify the consumer by also the item being dispensed for at least the instance of dispensing and can advantageously also be reused when the receptacle is reused.

For cases where the patient is likely to require repeat prescriptions (ie. further dispensing events as part of the ‘second mode of operation’ of the system), the patient will be required to complete their account by providing requisite information to the system (substantially in the same manner as has been described above with regard to the beverage dispensing application)—particularly, this process includes the patient providing their passcode as the second identifier (or electing to receive an auto-generated passcode for use as the second identifier), and, if required, providing the details of the third-party authentication service that the patient is subscribed to (either prescribed already, or as part of the account setup process). Additionally, the patient may also be asked to identify or designate a dispensing module (or distribution point) operable with the system that is located near where they live (or, alternatively, a dispensing module (or distribution point) is identified by the system based on the address details of the patient)—this allowing the patient to be appropriately authorised to receive/collect their repeat prescriptions from a dispensing module or distribution point near (or convenient to) where they live.

Once the patient has set up their account, they need only to make the necessary arrangements with their healthcare provider or medical practitioner for a repeat prescription (which may or may not involve a further medical consult), who then, as with the initial prescription, ensures that the medicament is supplied to the relevant dispensing module (or distribution point) for collection purposes. On presenting to the relevant dispensing module (or distribution point) to collect their repeat prescription (following advance notice as to when the relevant dispensing module/distribution point will carry stock of the prescribed medicament), the patient provides the first identifier (which is recognised/acknowledged by/at the dispensing module/distribution point), provides the second identifier, and, if required/enabled by the system, provides the third identifier provided by the patient's third-party identifier service. On completion of the latter, the dispensing module is then authorised to make available the prescribed medicament to the patient. All future medical appointments and associated prescriptions will follow the second mode of operation.

It is to be understood that the following claims are provided by way of example only and are not intended to limit the scope of what may be claimed in any such future application. Features may be added to or omitted from the provisional claims at a later date so as to further define or re-define the invention or inventions.

1. A system for facilitating procurement of a controlled or restricted item requested by a consumer, the system configured operable for enabling an authentication event in respect of the consumer's request, the authentication event involving an identifier and a characteristic associated with the identifier which provides an indication of successful verification of the consumer's eligibility to procure the controlled or restricted item, the identifier being associated with a type of the controlled or restricted item,
the system is further configured operable for authorising dispensing of the controlled or restricted item by way of a dispensing event on a determination of the characteristic indicating successful verification of the consumer's eligibility to procure the controlled or restricted item following acknowledgment of the identifier on presentation of the identifier at the dispensing event.

2. A system according to claim 1, wherein the identifier is physically associated with a receptacle device for receiving the controlled or restricted item.

3. A system according to claim 1, wherein the system is configured to only facilitate procurement of the controlled or restricted item of the type associated with the identifier into the receptable device associated with the identifier.

4. A system according to claim 1, wherein the procurement of the controlled or restricted item is requested from one of a network of a plurality of dispensing modules, wherein the dispensing modules are configured to only facilitate dispensing of the controlled or restricted item of the type associated with the identifier into the receptable device associated with the identifier.

5. A system according to claim 1, wherein the system is configured to read the identifier and to receive the type of item associated therewith and to dispense the item according to its type into the receptacle device upon the indication of the successful verification of the consumer's eligibility to procure the controlled or restricted item.

6. A system according to claim 4, wherein the dispensing module is configured to read the identifier from the receptacle device, wherein reading of the identifier triggers retrieving the type of item associated with the identifier and initiates the verification of the consumer's eligibility to procure the controlled or restricted item.

7. A system according to claim 5, wherein the system is configured such that upon reading of the identifier the system prepares the dispensing module to dispense the type of item associated with the identifier.

8. A system according to claim 5, wherein the dispensing module is configured to verify that the receptacle complies with dispensing requirements.

9. A system according to claim 1, wherein the receptacle device comprises a receptacle and a holder device for holding the receptacle, wherein the holder device supports the identifier.

10. A system according to claim 9, wherein the holder device comprises a physical compatibility interface between the receptacle and the holder device.

11. A system according to claim 10, wherein the physical compatibility interface is a keyed projection on the sleeve and a recess on the bottle.

12. A system according to claim 9, wherein the receptacle is separable from the holder device.

13-19. (canceled)

20. A device configured for holding or providing support for a receptacle, the device comprising an identifier configured operable so as to be acknowledgeable for use in an authentication event enabled by a system for facilitating procurement of a controlled or restricted item requested by a consumer from one of a network of a plurality of dispensing modules, or acknowledgeable by a dispensing apparatus operable for use in procurement of a controlled or restricted item when the device is presented thereto.

21. A system according to claim 2, wherein the system is configured to only facilitate procurement of the controlled or restricted item of the type associated with the identifier into the receptable device associated with the identifier.
